(19) United States
(12) Patent Application Publication
(10) Pub. No.: US 2018/0275654 A1
(43) Pub. Date: Sep. 27, 2018

(54) Unmanned Aerial Vehicle Control Techniques

(71) Applicant: Cmmonwealth Scientific and Industrial Research Organisation, Acton, ACT (AU)

(72) Inventors: Torsten Merz, Acton (AU); Farid Kendoul, Acton (AU); Stefan Hrabar, Acton (AU)

(73) Assignee: Commonwealth Scientific and Industrial Research Or ganisation, Acton, ACT (AU)

(21) Appl. No.: 15/756,880

(22) PCT Filed: Aug. 31, 2016
(86) PCT No.: PCT/AU2016/050820

§ 371 Date: Mar. 1, 2018

(30) Foreign Application Priority Data
Sep. 3, 2015 (AU) 2015903607

(51) Int. Cl. G05D 1/00; G05D 1/10; G08G 5/00; G08G 5/04; G01S 13/88; G01S 13/94; G01S 13/93; B64C 39/02

(52) U.S. Cl. CPC G05D 1/0077; B64C 2201/146; G05D 1/0033; G05D 1/0061; G05D 1/101; G08G 5/0013; G08G 5/0039; G08G 5/0069; G08G 5/006; G08G 5/045; G08G 5/0086; G01S 13/882; G01S 13/94; G01S 13/9303; B64C 39/024; G05D 1/0016

(57) ABSTRACT

A method of controlling an unmanned aerial vehicle executing a mission in a defined mission area including a first observation area within a Visual Line of Sight (VLOS) of a First Observer (FO), a second observation area within a VLOS of a second observer (SO), and a transition area within the VLOS of both the FO and the SO, the method including: the vehicle moving into the transition area after completing part of the mission within the first observation area, in sight of the FO; and in response to the vehicle moving into the transition area, determining whether the vehicle is in sight of the SO. The vehicle is including multiple processing systems in wireless communication with multiple remote user interfaces and a radar sensor mounted on the vehicle using a moveable mount for moving the radar sensor between different radar orientations, the radar sensor generating a range signal.

### BACKGROUND OF THE INVENTION

This invention relates to techniques for controlling an unmanned aerial vehicle, being particularly suitable for use during extended visual line of sight operations.

### DESCRIPTION OF THE PRIOR ART

Remotely piloted aircraft and unmanned aerial vehicles (UAVs) are increasingly being adopted across a variety of civil and military applications. However, aviation safety concerns have led to extensive regulation of UAV operations. This has held back widespread proliferation of UAVs, especially for operations near populated areas or other air traffic.

Aviation safety authorities often require that UAVs can only be operated if the vehicle remains within the visual line of sight of a remote pilot, so that the pilot is ready to take action to ensure safe operation of the vehicle and avoid collisions with other air traffic. However, this can greatly limit the types of missions that may be performed by UAVs.

In some jurisdictions, extended visual line of sight operations may be permitted in which the remote pilot is assisted by trained observers who may assume observation duties when the vehicle moves out of the visual line of sight of the remote pilot and communicate with the remote pilot if a safety issue or risk of collision is observed.

However, extended visual line of sight operations can involve significant risks due to the increased likelihood of human error or a breakdown in communications. It is therefore desirable to provide methods and apparatus which may improve the safety of extended visual line of sight operations of unmanned aerial vehicles.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a first broad form the present invention seeks to provide a method of controlling an unmanned aerial vehicle executing a mission in a defined mission area including a first observation area within a visual line of sight of a first observer, a second observation area within a visual line of sight of a second observer, and a transition area within the visual line of sight of both the first observer and the second observer, the method including:
a) the vehicle moving into the transition area after completing part of the mission within the first observation area, in sight of the first observer; and,
b) in response to the vehicle moving into the transition area, determining whether the vehicle is in sight of the second observer, wherein:
   i) if the vehicle is in sight of the second observer, the vehicle is allowed to continue the mission in the second observation area;
   ii) if the vehicle is not in sight of the second observer, determining whether the vehicle is in sight of the first observer, wherein:
      (1) if the vehicle is in sight of the first observer, causing the vehicle to:
         (a) abort the mission; and,
         (b) return to a base location via the first observation area; and,
      (2) if the vehicle is not in sight of the first observer, terminating flight of the vehicle.

Typically the method includes each of the first and second observers communicating with the other observer to confirm whether the vehicle is in their sight.

Typically the first and second observers communicate using wireless voice communications.

Typically the method includes, in response to a loss of wireless voice communications:

a) if the vehicle is in sight of the first observer, causing the vehicle to:
i) abort the mission; and,
ii) return to a base location via the first observation area; and,

b) if the vehicle is not in sight of the first observer but is in sight of the second observer:
i) causing the vehicle to perform a hovering maneuver; and,
ii) if wireless voice communications are not re-established within a predetermined duration, terminating flight of the vehicle.

Typically the method includes, when the vehicle moves into the transition area, the second observer communicating with the first observer to confirm whether the vehicle is in sight of the second observer.

Typically each of the first and second observers has a respective remote user interface for allowing the respective observer to input user commands, the method including the vehicle responding to user commands received from one of the remote user interfaces.

Typically the user commands include:

a) an abort command for causing the vehicle to:
i) abort the mission; and,
ii) return to the base location; and,

b) a terminate command for terminating flight of the vehicle.

Typically the method includes, when the vehicle moves into the transition area and if the vehicle is in sight of the first observer but is not in sight of the second observer, the first observer inputting an abort command.

Typically the method includes, if the vehicle is not in sight of any of the observers for a predetermined duration, either of the observers inputting a terminate command.

Typically the user commands further include:

a) a hover command for causing the vehicle to perform a hovering maneuver; and,

b) a duck command for causing the vehicle to perform a ducking maneuver.

Typically the method includes, when the vehicle moves into the transition area and if the vehicle is not in sight of any of the observers, either of the observers inputting a hover command.

Typically the method includes, when the vehicle is performing a hovering maneuver and if the first observer regains sight of the vehicle, the first observer inputting an abort command.

Typically the method includes, when the vehicle is performing a hovering maneuver and if the first observer fails to regain sight of the vehicle within a predetermined hover duration, the first observer inputting a terminate command.

Typically the method includes, if one of the observers identifies a risk of collision between the vehicle and air traffic in the respective observation area, the observer inputting a duck command.

Typically each remote user interface includes:

a) a command input for allowing a user to input at least an abort command; and,

b) a kill switch for allowing a user to input a terminate command.

Typically the method includes causing the vehicle to perform a maneuver in response to activation of the command input depending on at least one of:

a) a duration of the activation;

b) a current flight mode of the vehicle; and,

c) a number of activations in a defined time period.

Typically at least one of the observers wears spotting glasses coupled to the respective remote user interface, the method including causing the spotting glasses to provide visual indicators for prompting the observer to look towards the vehicle.

Typically the spotting glasses include:
a) an orientation sensor for providing orientation data;
b) a sight positioned in an observer's field of view when worn; and,
c) pan and tilt indicator lights, wherein the method includes selectively activating the pan and tilt indicator lights based on the orientation data to prompt the observer to rotate their head to so that the sight points towards the vehicle.

Typically the method includes the remote user interface selectively activating the pan and tilt indicator lights by:
a) comparing position data indicative of the respective positions of the observer and the vehicle to determine a required orientation;
b) comparing the orientation data to the required orientation to determine required rotations to achieve the required orientation; and,
c) selectively activating the pan and tilt indicator lights to indicate the required rotations.

Typically the method includes causing the remote user interface to provide information to the respective observer using speech output.

Typically the method includes:
a) the vehicle returning to the transition area whilst returning to the base location from the second observation area, in sight of the second observer; and,
b) in response to the vehicle moving into the transition area, determining whether the vehicle is in sight of the first observer, wherein:
   i) if the vehicle is in sight of the first observer, the vehicle is allowed to continue to return to the base location via the first observation area; and,
   ii) if the vehicle is not in sight of the first observer, terminating flight of the vehicle.

Typically the first observer is a pilot having a remote control interface for allowing the pilot to input flight commands, the method including the vehicle responding to flight commands received from the remote control interface.

Typically the method includes, if one of the observers identifies a risk of collision between the vehicle and air traffic in the respective observation area, the pilot inputting flight commands to take over control of the vehicle.

Typically the mission area includes a plurality of observation areas, each having a respective observer, and a plurality of transition areas in overlapping areas of adjacent pairs of the observation areas, the method including the vehicle returning to the base location via any transition areas between the current vehicle position and the base location.

In a second broad form the present invention seeks to provide a method of controlling an unmanned aerial vehicle executing a mission in a defined mission area, the vehicle including one or more processing systems in wireless communication with one or more remote user interfaces, the method including, in the one or more processing systems:
a) detecting whether the vehicle has encountered an abort condition or a terminate condition based on at least one of:
   i) a user command received from a remote user interface; and,
   ii) sensor data received from sensors of the vehicle;
b) in response to detecting an abort condition:
   i) causing the vehicle to:
      (1) abort the mission; and,
      (2) return to a base location within the mission area; and,
   ii) detecting whether the vehicle has subsequently encountered a terminate condition while returning to the base location; and,
c) in response to detecting a terminate condition, terminating flight of the vehicle.

Typically the abort condition includes at least one of:
a) receiving, from the remote user interface, an abort command; and,
b) detecting, based on the sensor data, a non-critical issue that will inhibit execution of the mission.

Typically the non-critical issue includes at least one of:

a) a low fuel level;

b) a low battery charge level;

c) an engine warning;

d) a mission equipment malfunction;

e) entering a geofence buffer zone;

f) deviation from a vehicle flight envelope; and,

g) an excessive trajectory tracking error.

Typically the method includes detecting the low fuel level by at least one of:

a) determining that a fuel level is below a predetermined fuel level threshold; and,

b) determining that the fuel level is insufficient to complete the mission.

Typically the method includes detecting the low battery charge level by determining that a battery charge level is below a predetermined battery charge threshold.

Typically the method includes deviation from the flight envelope by determining that flight parameters of the vehicle are outside vehicle flight envelope parameters.

Typically the method includes detecting the excessive tracking error by determining that a trajectory tracking error is greater than a predetermined tracking error threshold.

Typically the terminate condition includes at least one of:
a) receiving, from the remote user interface, a terminate command; and,
b) detecting, based on the sensor data, a critical issue that will prevent safe operation of the vehicle.

Typically the critical issue includes at least one of:

a) the vehicle leaving the mission area;

b) a loss of a global positioning system signal;

c) a loss of wireless communication with the one or more remote user interface units;

d) an unrecoverable malfunction of an avionics system of the vehicle;

e) a failure of a critical sensor of the vehicle;

f) a failure of a flight computer of the vehicle;

g) a failure of an inertial measurement unit of the vehicle;

h) a failure of an attitude and heading reference system of the vehicle; and,

i) a failure of an electric power system of the vehicle.

Typically the critical sensor includes at least one of:

a) a pressure altimeter of the vehicle;

b) a positioning sensor of the vehicle; and,

c) a radar sensor of the vehicle.

Typically the vehicle includes an obstacle detection sensor, the method including detecting an abort condition when the obstacle detection sensor detects an object ahead of the vehicle while the vehicle is executing the mission.

Typically the method further includes detecting a terminate condition when the obstacle detection sensor detects an object ahead of the vehicle while the vehicle is returning to the base location after the mission has been aborted.

Typically the one or more processing systems provide a guidance module for generating flight commands and a flight control module for controlling flight of the vehicle based on the flight commands, the method including:
a) in the absence of an abort condition or a terminate condition, the guidance module generating flight commands for causing the vehicle to execute the mission according to a predefined mission flight plan; and,
b) in response to detecting an abort condition, the guidance module generating flight commands for causing the vehicle to return to a base location.

Typically the method includes, in response to detecting an abort condition, the guidance module generating a return to base flight plan for returning the vehicle from a current vehicle position to the base location.

Typically the mission area includes first and second observation areas and a transition area in an overlapping area of the first and second observation areas, the method including the guidance module generating the return to base flight plan so that the vehicle returns to the base location via the transition area.

Typically the mission area includes a plurality of observation areas and a plurality of transition areas in overlapping areas of adjacent pairs of the observation areas, the method including the guidance module generating the return to base flight plan so that the vehicle returns to the base location via any transition areas between the current vehicle position and the base location.

Typically each remote user interface includes:

a) a command input for allowing a user to input an abort command; and,

b) a kill switch for allowing a user to input a terminate command.

Typically the method includes causing the vehicle to perform a maneuver in response to activation of the command input depending on at least one of:

a) a duration of the activation;

b) a current flight mode of the vehicle; and,

c) a number of activations in a defined time period.

Typically the method includes causing the vehicle to:
a) perform a ducking maneuver in response to a short activation of the command input; and,
b) perform a hovering maneuver in response to a long activation of the command input.

Typically the method includes receiving an abort command in response to another long activation of the command input when the vehicle is performing a hovering maneuver.

In a third broad form the present invention seeks to provide an unmanned aerial vehicle including:
a) a radar sensor mounted on the vehicle using a moveable mount for moving the radar sensor between different radar orientations, the radar sensor generating a range signal; and,
b) one or more processing systems for providing:
   i) a mount control module configured to control the moveable mount to move the radar sensor into one of the radar orientations based on a current one of a plurality of flight modes; and,
   ii) a flight control module configured to control flight of the vehicle using the range signal, based on the current flight mode.

Typically the plurality of flight modes includes an obstacle avoidance mode, in which:
a) the mount control module causes the moveable mount to move the radar sensor into an obstacle avoidance orientation in which the range signal is indicative of a distance between the vehicle and any object in a flight direction of the vehicle; and,
b) the flight control module initiates at least one obstacle avoidance measure if the range signal falls below an obstacle avoidance range threshold.

Typically the obstacle avoidance orientation points the radar sensor in one of:

a) a substantially forward direction relative to the vehicle; and,

b) a direction that is substantially aligned with the flight direction of the vehicle.

Typically the at least one obstacle avoidance measure includes at least one of:

a) causing the vehicle to decelerate;

b) causing the vehicle to hover;

c) causing the vehicle to climb in altitude;

d) causing the vehicle to attempt to steer around an object;

e) causing the vehicle to abort a mission; and,

f) causing the vehicle to return to a base location.

Typically the at least one obstacle avoidance measure includes at least one of:
a) causing the vehicle to decelerate to a stop then automatically return to a base location; and,
b) causing the current flight mode of the vehicle to transition from the obstacle avoidance mode to a different one of the plurality of flight modes.

Typically the obstacle avoidance mode is activated as the current flight mode when the vehicle is executing a mission.

Typically the obstacle avoidance range threshold is determined based on at least one of:

a) a flight speed of the vehicle; and,

b) a flight direction of the vehicle.

Typically the plurality of flight modes includes a terrain following mode, in which:
a) the mount control module causes the moveable mount to move the radar sensor into a terrain following orientation in which the range signal is indicative of a distance between the vehicle and terrain ahead of the vehicle; and,
b) the flight control module causes the vehicle to maintain at least a minimum separation from the terrain based on the range signal.

Typically the terrain following orientation points the radar sensor in an angled direction that is rotated downwardly from a forward direction relative to the vehicle, to thereby allow the radar sensor to detect the terrain ahead of the vehicle and any object in a flight direction of the vehicle.

Typically the angled direction is at least one of:
a) rotated downwardly from the forward direction by an angle of between 30 degrees and 60 degrees; and,
b) rotated downwardly from the forward direction by an angle of approximately 45 degrees.

Typically, in the terrain following mode, the flight control module causes the vehicle to maintain at least the minimum separation from the terrain by controlling an altitude of the vehicle above the terrain.

Typically, in the terrain following mode, the flight control module controls the altitude of the vehicle between a maximum altitude limit and a minimum altitude limit that provides the minimum separation from the terrain.

Typically, in the terrain following mode, the flight control module increases the altitude of the vehicle when the range signal falls below a terrain following range threshold.

Typically, in the terrain following mode, the flight control module regulates a ground speed of the vehicle based on the range signal.

Typically the terrain following mode is activated as the current flight mode when the vehicle has aborted a mission and is returning to a base location.

Typically the plurality of flight modes includes a vertical flight mode, in which:
a) the mount control module causes the moveable mount to move the radar sensor to an altimeter orientation in which the range signal is indicative of an altitude of the vehicle above terrain beneath the vehicle; and,
b) the flight control module controls vertical flight of the vehicle based on the range signal.

Typically the altimeter orientation points the radar sensor in a downward direction relative to the vehicle, to thereby allow the radar sensor to detect the terrain beneath the vehicle.

Typically the vertical flight mode is activated as the current flight mode when the vehicle is performing at least one of:

a) a take-off maneuver;

b) a landing maneuver;

c) a hovering maneuver;

d) a ducking maneuver; and,

e) an altimeter adjustment maneuver.

Typically, during a ducking maneuver, the flight control module causes the vehicle to descend until the range signal reaches a ducking range threshold.

Typically, in the vertical flight mode, the flight control module uses the range signal to determine a height above ground estimation, the height above ground estimation being used to adjust a pressure altimeter of the vehicle.

Typically the mount control module is configured to control the moveable mount to move the radar sensor into one of the radar orientations based on at least one of:

a) a velocity of the vehicle; and,

b) an altitude of the vehicle.

It will be appreciated that features of the different forms of the invention as described above may be used interchangeably in other forms of the invention.

### BRIEF DESCRIPTION OF THE DRAWINGS

An example of the present invention will now be described with reference to the accompanying drawings, in which:—

FIG. 1 is a schematic diagram of an example of an unmanned aerial vehicle system including an unmanned aerial vehicle and remote user interfaces for use by observers;

FIG. 2 is a schematic diagram of an example of a flight computer of the unmanned aerial vehicle;

FIG. 3 is a schematic diagram of a mission area in relation to the visual line of sight of first and second observers;

FIG. 4 is a flow chart of an example of a method of controlling the unmanned aerial vehicle when transitioning observation duties between the first and second observers;

FIGS. 5A and 5B are flow charts of an example of a practical implementation of the method of FIG. 4;

FIG. 6 is a flow chart of an example of a method of controlling the unmanned aerial vehicle in response to detecting an abort condition or a terminate condition;

FIGS. 7A and 7B are flow charts of an example of a method of controlling the unmanned aerial vehicle using a moveable radar sensor;

FIG. 8 is a schematic diagram of a state machine representing the operation of the unmanned aerial vehicle system in response to activations of a command input of one of the remote user interfaces;

FIG. 9 is a schematic diagram of a state machine representing the operation of the unmanned aerial vehicle system in response to activations of a kill switch of one of the remote user interfaces;

FIG. 10 is a schematic diagram of a state machine representing a monitoring functionality of the unmanned aerial vehicle system; and,

FIG. 11 is a schematic diagram of an example of spotting glasses for use by an observer.

### DETAILED DESCRIPTION OF THE PREFERRED EMBODIMENTS

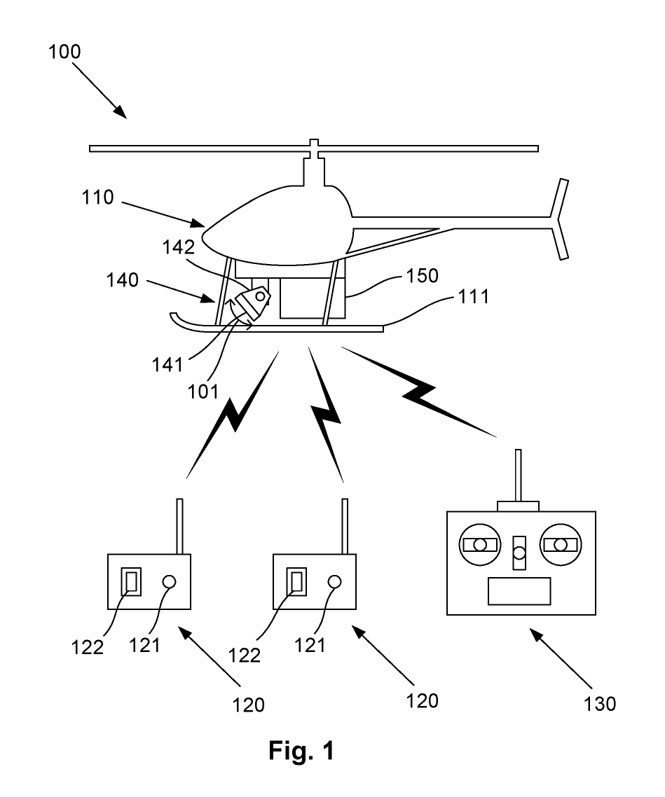

Examples of methods for controlling the operation of unmanned aerial vehicles will now be described. These examples will be described in the context of an example unmanned aerial vehicle system 100 as shown in FIG. 1.

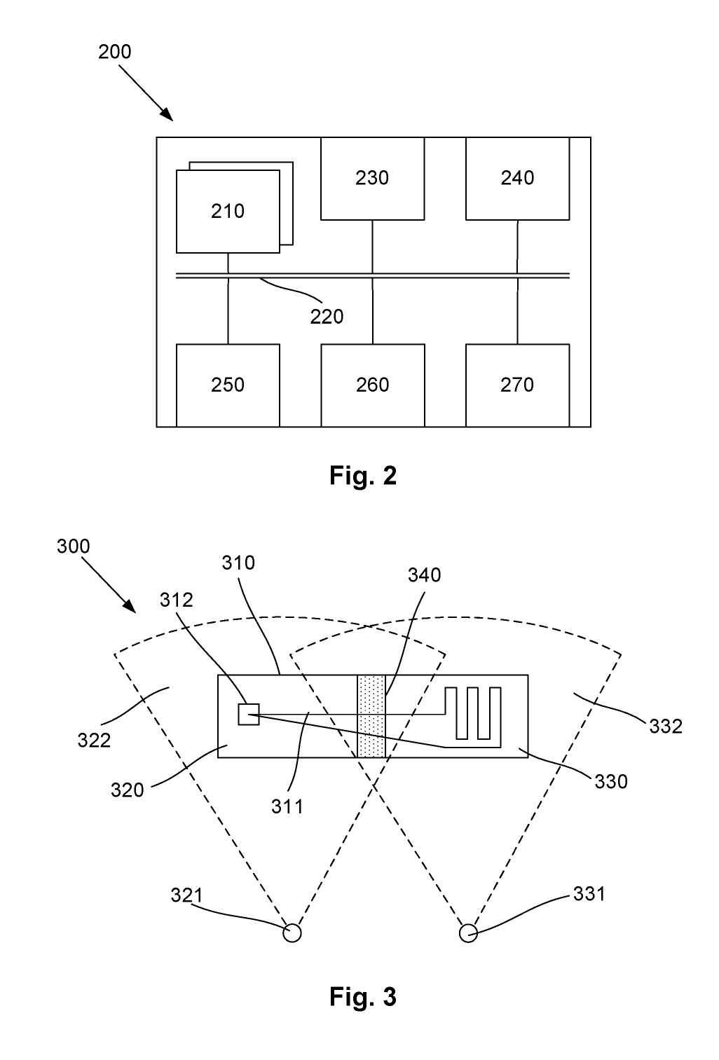

The system 100 includes an unmanned aerial vehicle 110, typically in the form of an aircraft such as a rotary wing aircraft or fixed wing aircraft that is capable of self-powered flight. In this case, the vehicle 110 is a single rotor helicopter although it will be appreciated that other vehicles 110 may include dual rotor helicopters, quadrotor drones, aeroplanes, or the like. The vehicle 110 will typically be capable of fully autonomous flight and will typically include a flight computer 200 as shown in FIG. 2, which includes one or more processing systems 210 configured to interface with components of the vehicle 110 such as sensors and actuators along with other elements of the system 100, and control the flight of the vehicle 110 accordingly.

The system 100 further includes a number of remote user interfaces 120 in wireless communication with the vehicle 110. The remote user interfaces 120 are provided to allow users on the ground, typically observers, to remotely input commands to the vehicle 110. In this example, two remote user interfaces 120 are provided to enable operations where the remote user interfaces 120 are operated by first and second observers as discussed below, however it should be appreciated that any number of remote user interfaces 120 may be used depending on the number of observers required.

In preferred examples, the remote user interfaces 120 have a simplified configuration and only include two inputs, in the form of a command input 121 and a kill switch 122, and further details of how these inputs may be used to control the vehicle 110 will be outlined in due course. The remote user interfaces 120 may include a user feedback device such as a speaker, buzzer, vibration generator or the like which allows feedback to be provided to a user depending on inputs provided by the user or the occurrence of particular events during the operation of the vehicle 110.

The system 100 may optionally include a remote controller 130 which allows a user, typically designated as a pilot, to have full manual control over the flight of the vehicle 110. In some cases the pilot may be one of the aforementioned observers. The remote controller 130 will typically be of conventional configuration commonly used for controlling remote controlled aircraft and the like. Alternatively, the remote controller 130 may be provided using any suitable computer system capable of communicating with the vehicle 110 during its flight. For instance, the remote controller 130 may be implemented using application software executed on a mobile device in wireless communication with the vehicle 110. It is noted that a number of commercially available unmanned aerial vehicles are configured for control using a software application on a touch-screen enabled mobile device.

In some examples, a ground control station (GCS) may optionally be provided as part of the system 100. The GCS may integrate functionalities of one of the remote user interfaces 120 and/or the remote controller 130. Additionally or alternatively, the GCS may provide extended functionalities not available using the remote user interfaces 120 and/or the remote controller 130. Whilst it may be useful to deploy a GCS for operations of the system 100, it should be noted that the GCS is not essential and the functionalities to be discussed below may be implemented without use of a GCS.

In preferred embodiments, the vehicle 110 may include a moveable radar arrangement 140 including a radar sensor 141 mounted on the vehicle 110 using a moveable mount 142 for moving the radar sensor 141 between different radar orientations as indicated by the arrow 101. Further details of the use of the moveable radar arrangement 140 in controlling the operation of the vehicle 110 will be described in later examples.

The vehicle 110 may also carry a payload 150 which may include a range of different mission equipment, such as camera systems, non-flight sensors or the like. A landing gear 111 of the vehicle will typically be configured to allow the vehicle to touch down on the ground during landing without damage to the payload 150 or other equipment which may be mounted beneath the main body of the vehicle 110.

An example of a suitable flight computer 200 of the unmanned aerial vehicle system 100 will now be described with regard to FIG. 2. As mentioned above, the flight computer 200 will typically include one or more processing systems 210 having at least one processor and memory, along with a number of interfaces for allowing the flight computer 200 to interface with other elements of the vehicle 110, with the processing systems 210 and equipment being interconnected via a bus 220 as shown.

In this example, the interfaces include the following:
Sensor interfaces 230 for allowing the processing systems 210 to receive sensor data from sensors of the vehicle 110;
Actuator interfaces 240 for allowing the processing systems 210 to output actuator data for controlling actuators of the vehicle 110, including flight actuators;
Remote user interface communications interfaces 250 for allowing the processing systems 210 to communicate with the remote user interfaces 120;
A remote controller communications interface 260 for allowing the processing systems 210 to communicate with the remote controller 130; and,
Mission equipment interfaces 270 for allowing the processing systems 210 to receive mission data from or control any mission equipment equipped on the vehicle 110, such as a camera system or the like.

Further details of practical implementations of the flight computer 200 will be described in due course. However, it should be appreciated that the flight computer 200 is not necessarily provided by a single processing system 210 and its functionalities and/or the above discussed interfaces may be provided in a distributed arrangement across multiple processing systems 210, which may be physically located in different parts of the aircraft.

For instance, in one example, the processing systems 210 of the flight computer may be provided as part of the payload 150 rather than being directly integrated with the avionics of the vehicle 110. The remote controller communications interface 260 may be provided as an integral system of the vehicle 110, particularly if the vehicle 110 is based on an off-the-shelf remote controlled aircraft or the like. Actuator interfaces 240 may also be provided with the vehicle 110 itself, although there may be exceptions, such as the interface with a fuel pump if this is connected to a non-standard external fuel tank or the like. The remote user interface communications interfaces 250 may be provided as part of the payload 150. Similarly, the mission equipment interfaces 270 may be provided as part of the payload 150, along with any associated mission equipment computers such as for enabling image capture. The bus 220 may interconnect the above discussed elements provided as part of the vehicle 110 and the payload 150. An electric power system will typically be provided for supplying power to the equipment of both the payload 150 and the vehicle 110.

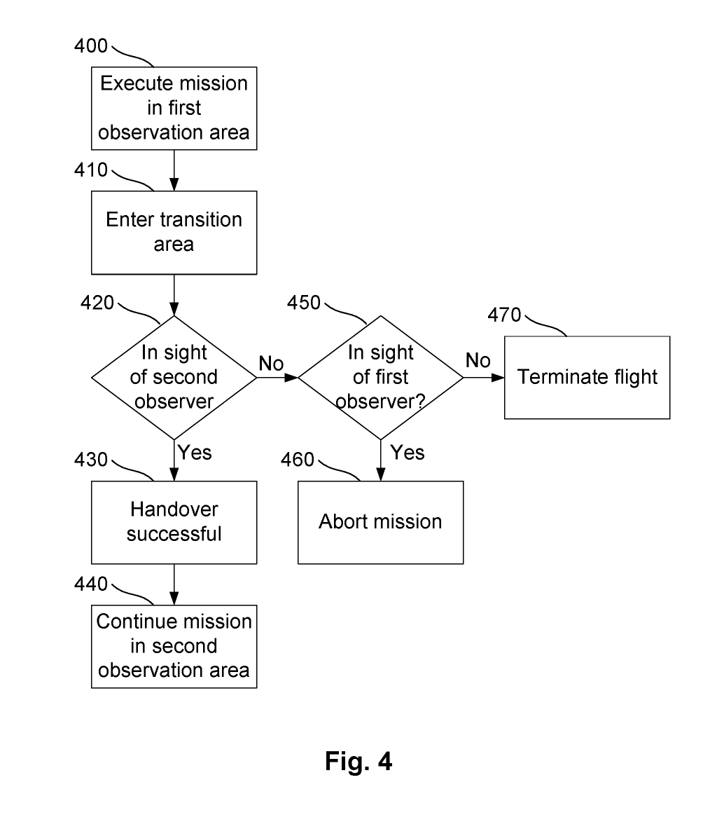

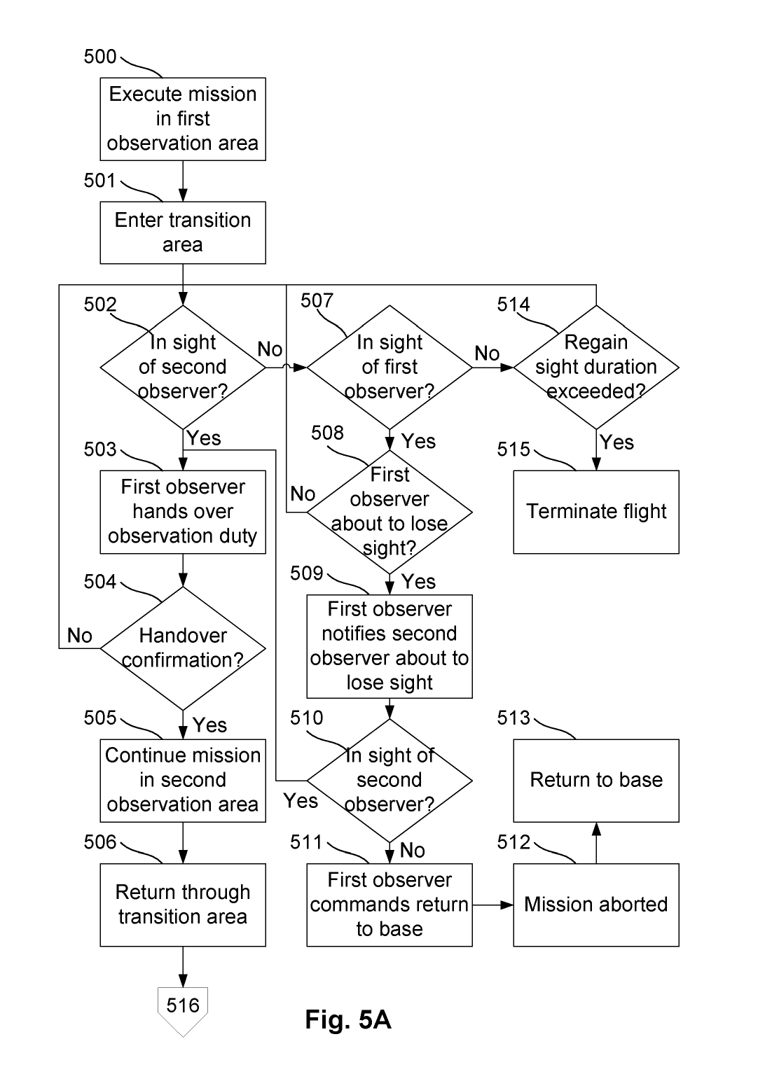

An example of a method of controlling the unmanned aerial vehicle 110 to enable extended visual line of sight operations will now be described, with reference to the example operational area 300 depicted in FIG. 3 and the flow chart of FIG. 4.

With regard to FIG. 3, the operational area 300 includes a defined mission area 310 in which the vehicle 110 is to execute a mission. The mission area 310 includes a first observation area 320 within a visual line of sight 322 of a first observer 321, a second observation area 330 within a visual line of sight 332 of a second observer 331, and a transition area 340 within the visual line of sight of both the first observer 321 and the second observer 331. Typically, the mission of the vehicle 110 will involve flight along a defined flight path 311 that starts and ends at a defined base location 312. However, there may be cases where the mission is one-way, involving landing at a new location. For example, when inspecting a power line, it may be more efficient to take off at one end of the power line and land at the other. In this example, the base location 312 is within the first observation area 320 although this is not essential.

It will be appreciated that the flight path 311 and arrangement of the observation areas 320, 330 and transition area 340 are illustrative only, being simplified to aid explanation and not necessarily representative of practical arrangements.

This method is applicable to extended visual line of sight operational scenarios in which the mission involves a flight path 311 that extends outside of the visual line of sight of the first observer 321 such that the second observer 331 is needed to effectively extend the mission area 310 whilst allowing the vehicle 110 to remain within the visual line of sight of an observer 321, 331 at all times during the mission.

An observer 321, 331 is responsible for maintaining the vehicle in sight at all times while the vehicle 110 is within their respective observation area 320, 330. The main task of the observers 321, 331 is to ensure safe operation of the vehicle 110, by avoiding collisions with other traffic. In preferred examples, the observers 321, 331 will have the ability to override the autonomous operation of the vehicle if needed to remove any observed collision risk, or to terminate the flight of the vehicle in safety critical scenarios.

When the vehicle 110 moves from the first observation area 320 to the second observation area 330, this will be via the transition area 340 where the two observation areas 320, 330 overlap. The observation duties need to be handed over between the observers 321, 331 to ensure at least one of the observers 321, 331 has visual contact with the vehicle 110 at all times.

Turning to the flowchart of FIG. 4, the method of controlling the vehicle 110 in the context of a handover between the first and second observers 321, 331 in the above described operational area 300 will now be outlined in broad terms.

The method starts at step 400 whilst the vehicle 110 is in the process of executing the mission within the first observation area 320.

At step 410, the vehicle 110 moves from the first observation area 320 into the transition area 340 after completing part of its mission within the first observation area 320, in sight of the first observer 321. In response to the vehicle moving into the transition area 340, the next step 420 involves determining whether the vehicle 110 is in sight of the second observer 331. This will usually involve having the second observer 331 check whether visual contact with the vehicle 110 can be made whilst the vehicle 110 is in the transition area 340. The following steps are dependent on the outcome of this determination in step 420.

Preferably, the relevant observers 321, 331 should have a reliable way of determining whether the vehicle 110 has moved into the transition area 340. In some mission areas 310 with clear sight lines and visible reference points available to the observers 321, 331, movement into the transition area 340 may be reliably judged based on visual observation of the vehicle 100 only. For instance, observers may be briefed before a mission on the location of a transition area 340 relative to landmarks in their respective observation areas 320, 330.

However, in some mission areas 310, visual judgement of the vehicle's position may not alone be sufficient to allow observers 321, 331 to determine whether the vehicle 110 has moved into the transition area 340. The observers 321, 331 will typically not receive telemetry from the vehicle 110 and observer handover may be required in different environments with little or no obvious landmarks that observers 321, 331 can use in their judgments.

In some implementations, the observers 321, 331 may operate under a protocol of continuous or intermittent communication so that the observers 321, 331 remain apprised of the movements of the vehicle 110 and are thus prepared when the vehicle 110 is about to enter the transition area 340. In some examples, the vehicle 110 may be configured to automatically notify the observers 321, 331 when a transition area 340 is being entered, such by providing user feedback via the remote user interfaces 120. In other examples, the vehicle 110 may be configured to perform a particular time-limited “spotting” maneuver upon entering a transition area 340 to provide observers 321, 331 with a better opportunity to make visual contact with the vehicle 110.

It should be noted that the precise boundaries of the transition area 340 are of lesser importance than the fact that the transition area 340 represents a region of overlapping observation areas 320, 330 in which the vehicle 110 should be visible to both observers 321, 331. Ideally the transition area 340 will be sufficiently large to allow some time for an observer 321, 331 to reliably achieve visible contact with the vehicle 110 in normal circumstances. In any event, further details of practical techniques for assisting observers 321, 331 to determine when the vehicle 110 has moved into the transition area 340 will be discussed in due course.

In the event that the vehicle 110 is in sight of the second observer 331 at step 420, the handover of observation duties from the first observer 321 to the second observer 331 is considered to be successful at step 430, and the vehicle 110 is allowed to continue the mission in the second observation area 330 at step 440. Preferably, the first and second observers 321 will be able to communicate with one another so that the second observer 331 can provide confirmation to the first observer 321 that the vehicle 110 is in sight and that the second observer 331 is ready to take over observation duties from the first observer 321.

However, in the event that the vehicle 110 is not in sight of the second observer 331 at step 420, a further determination is made at step 450 as to whether the vehicle 110 is still in sight of the first observer 321. For example, the second observer 331 may notify the first observer 321 that visual contact with the vehicle 110 could not be made so that the first observer 321 can take appropriate actions to prevent potential operation of the vehicle 110 without visual contact, as may occur if the vehicle is allowed to continue its mission outside of the transition area.

If the vehicle 110 is still in sight of the first observer 321, the method includes causing the vehicle 110 to abort the mission at 460 and subsequently return to the base location 312 via the first observation area 320. This branch of the procedure represents a failed transition of observation duties from the first observer 321 to the second observer 321, but in which the vehicle 110 is still within the visual line of sight of the first observer 321 and thus is safely recoverable without losing visual contact. The abandonment of the mission and return to the base location 312 may be initiated by either observer 321, 322, but will more preferably be handled by the first observer 321 since that observer will be directly aware of whether the vehicle 110 is still in sight.

In preferred implementations, the mission may only be aborted at step 460 when the first observer 321 is about to lose sight of the vehicle 110, such as when the vehicle 110 is about to move out of the transition area 340 so that it is only in the second observation area 330 and no longer in the first observation area 320. Thus, if the handover has been unsuccessful (or if success of the handover is not confirmed by the second observer 331), the first observer 321 may opt to allow the vehicle 110 to continue its flight whilst it is still in sight of the first observer 321 (thus allowing a further opportunity for the second observer 331 to make visual contact). Nevertheless, the mission should be aborted while the first observer 321 is still in sight of the vehicle 110 to ensure the vehicle 110 does not continue its flight into the second observation area 330 without visual contact.

On the other hand, if the vehicle 110 is not in sight of the first observer 321 at step 450, the method includes terminating flight of the vehicle 110 at step 470. In this case, neither of the observers 321, 331 has visual contact with the vehicle 110 and the flight of the vehicle 110 is terminated as a safety precaution to avoid further potentially dangerous flight without being in sight of an observer 321, 322.

It should be appreciated that termination of the flight of the vehicle 110 at step 470 does not necessarily occur immediately after both observers 321, 331 have lost visual contact with the vehicle 110. In preferred examples, a predefined duration of time may be provided for allowing observers 321, 331 to make visual contact with the vehicle 110 before finally terminating the flight of the vehicle 110. For instance, if the vehicle 110 is not in sight of the first observer 321 at step 450, the observers 321, 331 may continue to try to make or restore visual contact with the vehicle 110 without terminating the flight of the vehicle 110 for a period of time, until a regain sight duration has been exceeded, in which case the flight of the vehicle 110 should be terminated as per step 470.

The termination of flight of the vehicle 110 can be initiated, for example, by either of the observers 321, 322, such as by activation of a kill switch, or the like, on a remote user interface 120 in communication with the vehicle 110, to thereby issue a termination command to the vehicle 110. The termination may involve stopping the engine of the vehicle 110 and potentially activating other control inputs to effectively terminate flight as soon as practical. For example, in a vehicle 110 in the form of a rotary wing aircraft such as a helicopter, full collective pitch may be applied to the rotor in addition to stopping the engine, to thereby result in a ballistic trajectory flight of the helicopter to the ground ensuring impact within a short distance after activation.

In some optional variations of the method, the termination of the flight of the vehicle 110 may be deferred until after having the vehicle perform a hovering maneuver in which the vehicle 110 is caused to hover and gain altitude to a predetermined ceiling as a final attempt to allow the first observer 321 to re-attain visual contact with the vehicle 110. If the hovering maneuver causes the vehicle to once again come into sight of the first observer 321, the method may include causing the vehicle 110 to abort the mission as per step 460 and subsequently return to the base location 312 via the first observation area as per step 470.

It should be noted that references to first and second observers 321, 331 and their respective observation areas 320, 330 in the context of the above described method merely refers to the order in which the observers 321, 331 are encountered during the handover and is not otherwise intended to designate the particular observers 321, 331 taking part in the handover. So when the vehicle 110 first moves through the transition area 340 in outward leg of the mission (i.e. away from the base location 312, observation duties will be handed over from the first observer 321 to the second observer 331, but the reverse situation will apply when the vehicle 110 is on a returning leg of the mission and moves through the transition area 340 in the opposite direction. In other words, references to the first and second observers 321, 331 may be reversed in the method described above such that the method relates to a handover in the opposite direction of movement of the vehicle 110.

In any event, it will be appreciated that the above described method provides a framework for safely facilitating extended visual line of sight operations by ensuring that continued operation of the vehicle 110 occurs only when the vehicle is in sight of an observer 321, 331. The mission is only allowed to continue in the event of a successful handover of observation duties and if the handover is unsuccessful, the mission is aborted and the vehicle 110 is only allowed to return to base if it is possible to do so whilst still in sight of the first observer 321. Otherwise, the vehicle 110 is terminated if neither observer 321, 322 has the vehicle 110 in sight.

It is noted that the handover procedure in the above described method is important for allowing extended visual line of sight operations, and this may be driven by the need to comply with regulations of aviation authorities. It will be appreciated that, under particular regulatory frameworks, only certain specific implementations of the method may be in compliance with the relevant regulations. However, the method has been described in broad terms to facilitate better understanding of the overall handover procedure.

Further features of preferred embodiments of the method will now be described.

As mentioned above, each of the first and second observers 321, 331 will preferably be able to communicate with the other observer 321, 322 to confirm whether the vehicle 110 is in their sight. In preferred embodiments, the first and second observers 321, 331 communicate using wireless voice communications. In the context of the above described method, wireless voice communications will be particularly useful for allowing the second observer 231 to communicate with the first observer 221 to confirm whether the vehicle 110 is in sight of the second observer 231, when the vehicle moves into the transition area. However, it will be appreciated that wireless voice communications will also be useful in a range of other scenarios, as will be discussed in further detail in due course.

In some examples, the first and second observers 321, 331 may use two-way radios, such as handheld walkie-talkie devices or the like, to facilitate wireless voice communication. In other examples, the first and second observers 321, 331 may communicate using mobile telephones. The most suitable wireless voice communication technology will typically be selected depending on requirements including the communications range, availability of cellular network reception, etc. In preferred examples, each observer 321, 331 may have a handheld two-way radio as a primary communication device and have a mobile telephone as a backup communication device for use in the event of loss of communications using the primary communication device.

The method may include protocols for responding to a loss of wireless voice communications between the first and second observers 321, 331, such as in the event of failure of one of the observer's communication device, or a loss of communications signal between the devices. In particular, if wireless voice communications are lost when the vehicle 110 is in sight of the first observer 321, the method will include causing the vehicle 110 to abort the mission and return to a base location 312 via the first observation area 320. However, if the vehicle is not in sight of the first observer 320 but is in sight of the second observer, the method will include causing the vehicle 110 to perform a hovering maneuver, assuming it is safe to do so, to allow an opportunity to re-establish wireless voice communications before taking further action. This could involve either restoring wireless voice communications using primary communication devices or resorting to the use of backup communication devices.

Since one of the observers 321, 331 is still in visual contact with the vehicle 110 and able to issue commands to the vehicle 110 in the circumstances, the vehicle 110 can still be operated safely, although typically once the vehicle 110 is commanded to perform a hovering maneuver the mission will be aborted and the vehicle 110 will be commanded to return to the base location 312 in sight of the first observer 321 after wireless voice communications have been re-established.

However, it will be appreciated that it may be impossible to confirm the successful handover of observation duties in the absence of voice communications, and therefore a loss of wireless voice communications while the vehicle moves through the transition area 440 may be a safety critical issue. If wireless voice communications are not re-established within a predetermined duration, the flight of the vehicle 110 may be terminated, such as by having one of the observers 321, 331 activate the kill-switch of their user interface 120. It will be appreciated that the protocol for handling loss of wireless voice communications is similar to the above described case of an unsuccessful handover whilst the vehicle 110 is moving through the transition area 340.

As mentioned above, the observers 321, 331 may provide commands to the vehicle 110 using a remote user interface 120. In preferred embodiments of the method, each of the first and second observers 321, 331 may have a respective remote user interface 120 for allowing the respective observer 321, 331 to input user commands. Thus, the method may include having the vehicle 110 respond to user commands received from one of the remote user interfaces 120. The user commands may include an abort command for causing the vehicle 110 to abort the mission and return to the base location 312, and a terminate command for terminating the flight of the vehicle 110.

With regard to the method as shown in FIG. 4, the first observer 321 may input an abort command using the respective remote user interface 120 as per step 460 in the case when the vehicle 110 moves into the transition area 340 and the vehicle 110 is in sight of the first observer 321 but is not in sight of the second observer 331. If the vehicle 110 is not in sight of any of the observers 321, 331 for a predetermined duration, either of the observers may input a terminate command to terminate the flight of the vehicle 110 as per step 480.

In some examples, other user commands may be input using the remote user interfaces 120, including a hover command, which is used to cause the vehicle 110 to perform a hovering maneuver as previously discussed, and a duck command, which is used to cause the vehicle 110 perform a ducking maneuver, in which the vehicle 110 engages in a vertical descent towards the ground.

As mentioned above, the hovering maneuver may be used to gain time for wireless voice communications to be re-established in the event of these being lost. In addition, the hovering maneuver may also be used to cause the vehicle 110 to ascend to an elevated altitude compared to the altitude of the vehicle 110 while executing the mission, to thereby provide an opportunity for one of the observers 321, 331 to regain visual contact with the vehicle 110. It will be appreciated that higher altitude flight may cause the vehicle 110 to move into the line of sight of one of the observers 321, 331 if the vehicle had previously been obscured by low-lying objects such as trees.

Accordingly, in situations when the vehicle 110 moves into the transition area 340 and the vehicle 110 is not in sight of any of the observers 321, 331, either of the observers 321, 322 may input a hover command using their respective remote user interface 120.

Typically, inputting a hover command will stop the mission, and a further user command may be required to cease the hovering maneuver and cause the vehicle 110 to return to the base location 312. For example, when the vehicle 110 is performing a hovering maneuver and if the first observer 321 regains sight of the vehicle, the first observer 321 may input an abort command which causes the vehicle 110 to abort the mission and return to the base location 312. In the event that the vehicle 110 is performing a hovering maneuver and the first observer 321 fails to regain sight of the vehicle 110 within a predetermined hover duration, the first observer 321 may input a terminate command to thereby cause the flight of the vehicle 110 to be terminated.

The above described behaviour can help to ensure safe operation of the vehicle 110 by preventing the vehicle 110 from continuing the mission after a situation necessitating a hover maneuver has occurred. However, this behaviour is not essential and in some embodiments a hovering maneuver may be used to merely interrupt the mission, such that a further user command may allow the vehicle 110 to resume its mission after a hovering maneuver.

The ducking maneuver will usually involve controlling the altitude of the vehicle to maintain a separation from terrain or other objects such as trees beneath the vehicle 110. The duck command will typically be input by an observer 321, 331 when other air traffic is identified in the respective observation area 320, 330 and is deemed to present a risk of collision with the vehicle 110. Accordingly, if one of the observers 321, 331 identifies a risk of collision between the vehicle 110 and air traffic in the respective observation area, the observer 321, 331 may input a duck command using the respective remote user interface 120.

Inputting a duck command will typically stop the mission in a similar manner as discussed above for the hover command, with a further user command being required to cease the ducking maneuver and cause the vehicle 110 to return to the base location 312. For instance, when the collision risk has passed, such as when the other air traffic has left the vicinity of the current observation area 320, 330, the respective observer 321, 331 may input an abort command which causes the vehicle 110 to abort the mission and return to the base location 312. In alternative implementations, the mission could be resumed after a duck maneuver if both observers 321, 331 confirm that it is now safe to do so (no other air traffic). Nevertheless, it may be more preferable to configure the vehicle 110 to not resume the mission after a duck command, since any event causing a duck command to be input is considered to be rare and any mission variation would compromise the mission outcome in any event (e.g. by causing additional fuel consumption).

It is possible that visual contact with the vehicle 110 may be lost during a ducking maneuver, for instance due to the line of sight from the responsible observer 321, 332 to the vehicle 110 being obstructed by trees or other objects. Accordingly, once the collision risk has passed, a hover command may be input to cause the vehicle to perform a hovering maneuver and allow visual contact with the vehicle to be regained by one or both of the observers 321, 331. The above discussed hovering behaviour can then be implemented, in which one of the observers 321, 322 may input an abort command or a terminate command depending on whether visual contact with the vehicle 110 can be regained.

Preferably, each remote user interface 120 will have a simple interface to allow the observers 321, 331 to easily operate the remote user interface 120 whilst maintaining visual contact with the vehicle 110. In one example, the remote user interface 120 may include a command input 121 for allowing a user to input at least an abort command, and a kill switch 122 for allowing a user to input a terminate command. The command input 121 may be provided as a push button for ease of operation and to allow the button to be held to allow extended functionality as will be discussed below. The kill switch 122 will preferably be a guarded on/off switch so as to require a positive user action to remove the guard and thus help to prevent accidental termination of the flight of the vehicle 110. However, different configurations of the command input 121 and kill switch 122 may be used.

Whilst further inputs, switches or the like may be added to the remote user interface 120, this may be undesirable as it may clutter the interface and present a higher risk of user error in safety critical circumstances. By reducing the remote user interface 120 to only two inputs as discussed above, this allows the observers 321, 331 to focus on their observation duties as required yet be able to readily input an abort command or a terminate command in response to appropriate conditions arising. In one example, the remote user interface 120 may be designed for operation using two hands of a user, with each of the user's thumbs positioned over the command input 121 and the kill switch 122, respectively.

Although each remote user interface 120 may only include two inputs, the vehicle may be configured to respond to inputs received via a remote user interface 120 in different ways depending on different factors, to thereby extend the functionality afforded by the remote user interface 120. For instance, in some embodiments, the vehicle 110 may perform a maneuver in response to activation of the command input depending on particular circumstances such as the duration of the activation, a current flight mode of the vehicle 110, or a number of activations in a defined time period.

In one example, the duration of the activation of the command input may determine whether the vehicle 110 effectively receives a duck command or a hover command. A relatively short activation of the command input 121 may be interpreted as a duck command and a relatively long activation of the command input 121 (for example, by holding the command input for a predetermined duration such as two seconds) may be interpreted as a hover command. Since the duck command is more likely to be required in a safety critical scenario (i.e. when a collision risk is identified), this is easier to activate by pressing the command input, whereas the hover command required a deliberate holding activation.

Alternatively, multiple activations of the command input 121 may trigger different responses of the vehicle. For instance, a single activation of the command input 121 may be interpreted as a duck command, whilst two activations (e.g., when the command input 121 is a push button, a double push of the button) may be interpreted as a hover command. Multiple activations may need to be input within a predetermined time period to avoid being registered as separate single inputs.

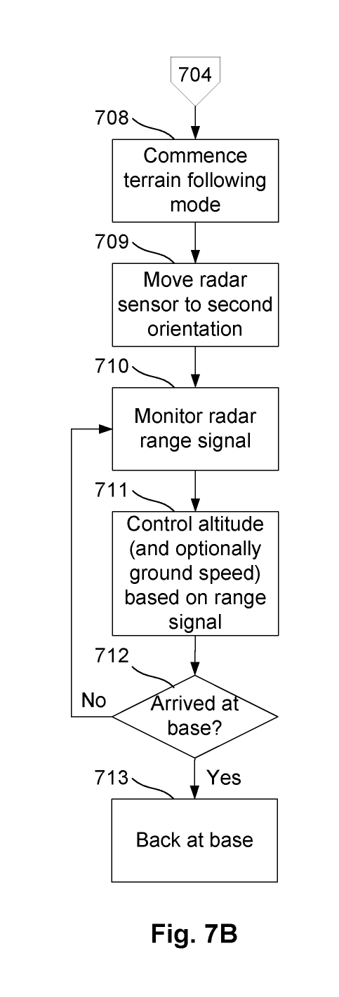

It will be appreciated that instances may arise in which different commands may be received from two different remote user interfaces 120 at the same time or within a short duration of one another. If different commands are simultaneously received by the vehicle, commands received from the kill switches 122 will be given priority over those received from the command input 121. In practice, multiple users will not typically be operating the command input 121 at the same time, since in normal circumstance actions will preferably be communicated to and coordinated by the remote pilot. In any event, if several separate command inputs activations are made, events are created in timely order and the reaction of the system is as shown in FIG. 8, which will be described in due course.

In other examples, the current flight mode of the vehicle may determine how the vehicle 110 responds to an activation of the command input. For instance, if the vehicle 110 is already performing a ducking maneuver, another activation of the command input 121 may be interpreted as an abort command to thereby cause the vehicle to abort its mission and return to the base location 312.

As mentioned above, the remote user interfaces 120 may include a capability for providing feedback to the user in certain circumstances. This feedback may be in the form of an audio signal or haptic feedback such as a vibration imparted to the remote user interfaces 120. The user may receive feedback in response to the input of user commands using the remote user interfaces 120, to confirm that the user command has been received and will be followed by the vehicle 110.

In one example, the system 100 may be configured so that the remote user interfaces 120 provide feedback to observers 321, 331 when the vehicle 110 enters or is about to enter the transition area 340, to thereby prompt the observers 321, 331 to take part in handover procedures as described above. However, this is not essential, and observers 321, 331 may simply be sufficiently familiar with their respective observation areas 320, 330 to know when the vehicle 110 has entered the transition area 340 by sight alone.

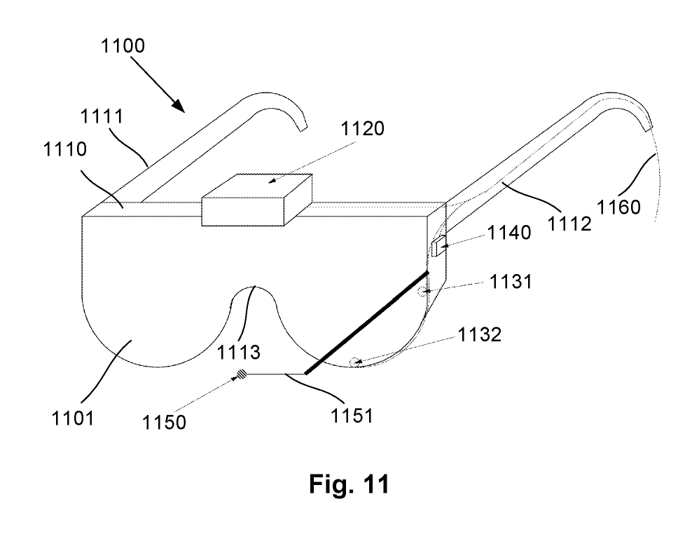

In some implementations, the remote user interfaces 120 may be coupled to spotting glasses 1100 as shown in FIG. 11, which may be used by the observers 321, 331 to aid in acquiring visual contact with the vehicle 110 during a handover of observation duties or in the event visual contact is temporarily lost. The spotting glasses 1100 will be configured to provide visual indicators for prompting the observer to look towards the vehicle 110. The spotting glasses 1100 will typically be used by observers that are required to spot the vehicle 110 over large distances.

With regard to FIG. 11, the spotting glasses 1100 will generally include a transparent lens 1101 provided in a frame 1110 that is hingedly connected to two arms 1111, 1112 in a conventional manner. The lens 1101 will preferably have no magnification and enable a wide field of view without undue obstruction by the frame 1110. Standard large safety glasses have been found to provide a suitable platform for the spotting glasses 1100, and these may be conveniently worn with other glasses as required by the observer, such as sunglasses or prescription/corrective lens glasses. However, it will be appreciated that the spotting glasses 1100 may be based on other types of available glasses or may be custom designed.

The spotting glasses 1100 include an orientation sensor 1120 which may be fitted to the frame 1110 in a position that is unlikely to substantially obstruct the observer's field of view, such as above a bridge region 1113 of the spotting glasses 1100. In some implementations, the orientation sensor 1120 may utilise similar sensor hardware as provided in the vehicle 110, although this is not essential. The spotting glasses 1100 also include pan and tilt indicator lights, in this case light emitting diodes (LEDs) 1131, 1132, a push button switch 1140, and a sight 1150. The electronic components of the spotting glasses 1100 may be connected to the remote user interface 120 through a flexible multi conductor cable 1160, which may extend along one of the arms 1112 as shown in FIG. 11. All components may be powered by the remote user interface 120.

In this example, the indicator lights include a pan LED 1131 and a tilt LED 1132, which may be positioned at edges of the lens 1101 so that these can be seen in the peripheral vision of an observer wearing the spotting glasses 1100. In this example, the pan LED 1131 is located on a left edge of the lens 1101 and the tilt LED 1132 is located on a lower edge of the lens 110 (from the observer's point of view). Thus the pan and tilt LEDs 1131, 1132 indicate how the observer should move his/her head so that the sight 1150 will point towards the vehicle 110. This is achieved by selectively activating the pan and tilt LEDs 1131, 1132 to prompt the observer to rotate their head in a suitable orientation so that the observer looks towards the vehicle.

In this example, the sight 1150 is provided as a small red ball which is suspended in front of the lens 1101 in the centre of the observer's field of view, using a narrow stalk 1151 extending from the frame 1110. By carefully selecting the size of the ball and its position relative to the observer's eyes, the sight 1150 may appear as a small blurry spot in the observer's eye as he/she typically focuses on infinity when attempting to make visual contact with a distant vehicle 110. Nevertheless, the spot provided by the sight 1150 provides the observer with a visual target for aiming their head based on visual cues provided by the pan and tilt LEDs 1131, 1132.

The LEDs 1131, 1132 will preferably be selected to be visible to the observer in bright sunlight. The LEDs 1131, 1132 are connected to a suitable controller in the remote user interface 120 so that these can be switched between on and off states depending on the orientation of the spotting glasses 1100, as determined using the orientation sensor 1120, with regard to the relative position of the vehicle 110. In one example implementation, the LEDs 1131, 1132 may be controlled to prompt the observer to move his/her head in the direction of an LED 1131, 1132 which is on.

For example, if the LED 1132 at the lower edge of the lens 1101 is on this means the observer should tilt their head down. Similarly, if the LED 1131 at the left edge of the lens 1101 is on, the observer should rotate their head to the left. The orientation of the observer's head will be correct (i.e. aiming at the vehicle 110) at the transition from LED on to LED off. When an LED 1131, 1132 is off, the observer must move their head in the opposite direction from where the LED is located, until the LED turns on.

It will be appreciated that reliable operation of the spotting glasses 1100 may require calibration of the spotting glasses 1100 to the observer. The spotting glasses 1100 should also be configured to allow the observer to repeatedly put on the glasses in the same orientation relative to the observer's retinas.

The remote user interface 120 may include a global positioning system (GPS) receiver for determining the observer's position, and may also be configured to receive position coordinates of the vehicle 110, which may be wirelessly transmission by the vehicle 110. Using the observer and vehicle position information, the remote user interface 120 can calculate a relative position of the vehicle 110 compared to the observer, and thus the viewing direction the user has to look to acquire visual contact with the vehicle 110. Then, this viewing direction can be compared with the orientation of the observer's head as determined by the orientation sensor 1120, which can be used to control the operation of the LEDs 1131, 1132 as discussed above.

More specifically, the remote user interface 120 selectively activates the pan and tilt indicator lights 1131, 1132 by comparing position data indicative of the respective positions of the observer and the vehicle 110 to determine a required orientation, comparing the orientation data to the required orientation to determine required rotations to achieve the required orientation, and selectively activating the pan and tilt indicator lights 1131, 1132 to indicate the required rotations.

In alternative embodiments, the remote user interface 120 may operate without a GPS receiver if the observer is in a predetermined observer position which is provided to the remote user interface 120.

In some implementations, the head orientation function may be normally disabled so as to not to irritate the observer with LED lights when the vehicle 110 is not nearby. When the observer requires assistance in acquiring visual contact with the vehicle 110, the spotting glasses 1100 can be activated by pushing the push button switch 1140. In one example, the spotting glasses 1100 may be activated for a short time sufficient to spot the vehicle 110, and automatically deactivated after a predetermined period of time.

Once the vehicle 110 has been spotted, the observer can track it without requiring the aid and may opt to manually deactivate the spotting glasses 1100 or simply allow these to deactivate automatically. However, in the event that the observer's view is occluded by trees or other structures, or the vehicle 110 is simply too far away, the spotting glasses 1100 may be used to point the observer's head in the correct direction. This may still provide sufficient information to make a decision if required to command an aircraft avoidance maneuver such as a ducking maneuver, to command a return flight, or to terminate the flight.

As mentioned above, the remote user interface 120 may also include a capability to provide audio feedback to an observer. In one example, this may be provided by incorporating a speech output function. For instance, the remote user interface 120 may include an OEM text to speech module and speakers. This speech output function may provide spoken cues to the observer and may allow a range of detailed information to be relayed to the observer without the need to break visual contact with the vehicle 110.

In some implementations, the spotting glasses 1100 may cooperate with the speech output function. For instance, the spotting glasses 1100 may be configured so that, when the push button switch 1140 is pushed, this will not only activate the head orientation function, but will also cause the remote user interface 120 to tell the observer other useful information, such as: distance of the vehicle 110 from the observer, its altitude, its bearing relative to the observer, where it's heading (track angle) and other status/health information. In some examples, the remote user interface 120 may be configured to automatically provide relevant spoken information in response to the vehicle 110 moving into the transition area, and may also automatically activate the spotting glasses 1100 without requiring the operator push to the push button switch 1140. In addition, the remote user interface 120 may produce a speech output for warnings at the time an event occurs (e.g. low fuel).

It should be noted that even when the observer can't see the vehicle 110, the information provided through the speech output function can be used to warn other aircraft or to determine if the vehicle 110 has left the mission area. Although similar information may be available on a conventional ground station display, the remote user interface 120 has been designed for an observer in the field who should be focussed on observing the airspace and not be distracted by looking at displays.

In some implementations, the vehicle 110 may be configured to execute a mission which includes automatically performing a predetermined maneuver when the vehicle 110 enters a transition area 340, to thereby assist in the transition of observation duties between observers 321, 331. For example, the vehicle 110 may automatically climb and hover for a predefined duration inside the transition area 340 to allow the second observer 331 to more easily establish visual contact with the vehicle 110 before the vehicle 110 leaves the transition area 340 and enters the second observation area 330. In other examples, the vehicle 110 may move through the transition area 340 at a significantly reduced speed or undertake a circling or loitering flight pattern for a period of time.

The above discussed handover of observation duties from the first observer 321 to the second observer 331 takes place when the vehicle 110 is moving from the first observation area 320 to the second observation area 330 during a mission, although similar transitions can occur when the vehicle 110 is moving from the second observation area 330 back into the first observation area 320, such as once the vehicle 110 has completed a part of its mission in the second observation area 330 and is returning to the base location 312 from the second observation area 330, or when the vehicle has received an abort command and is returning to the base location 312 after aborting the mission.

In either case, the following procedure may be applied to the transition of observation duties. When the vehicle returns to the transition area 340 whilst returning to the base location 312 from the second observation area 330, in sight of the second observer 321, a determination will be made as to whether the vehicle 110 is in sight of the first observer 321. If the vehicle 110 is in sight of the first observer 321, the vehicle 110 is allowed to continue to return to the base location 312 via the first observation area 320. On the other hand, if the vehicle 110 is not in sight of the first observer 321, the flight of the vehicle 110 may be terminated, such as by the first observer 321 inputting a terminate command using the respective remote user interface 120. However, prior to terminating the flight of the vehicle 110, the first observer 321 may optionally input a hover command to gain a further opportunity to establish visual contact with the vehicle 110, although if the vehicle does not come into the sight of the first observer 321 within a predetermined duration the flight of the vehicle 110 would be terminated.

Although the vehicle 110 will typically be configured to autonomously execute a mission, or in the event of the mission being aborted, autonomously return to the base location 312, it may nevertheless be desirable to provide a capability for a user to manually take over control of the vehicle, such as by using a remote control interface 130. This user may be referred to as a pilot, since this user may assume duties of remotely piloting the vehicle 110, even if the user does not actually pilot the vehicle 110 during normal autonomous operations.

Although the pilot may be a separate individual compared to the observers 321, 331, in some examples the first observer 321 is designated as the pilot and has a remote controller 130 for allowing the pilot to input flight commands, such that vehicle 110 may respond to flight commands received from the remote controller 130 should these be input by the pilot. In some implementations, the mission may be aborted as soon as any flight commands are manually input, since these would effectively override the mission. When the pilot is not responsible for remotely piloting the vehicle 110, the pilot may still perform observation duties as the first observer 321 when the vehicle is in the first observation area 320.

The pilot may opt to input flight commands to take over control of the vehicle 110 if one of the observers 321, 331 identifies a risk of collision between the vehicle 110 and other air traffic in the respective observation area 320, 330. Wireless voice communication may be used to communicate the identified risk to the pilot so that the pilot can take appropriate action to remove the risk. However, as discussed above, a ducking maneuver may be initiated by any of the observers 321, 331 in the even that the pilot is unable to take control of the vehicle 110.

Although the above examples only consider situations involving first and second observation areas 320, 330 with a single transition area 340 between them, it should be appreciated that the described method may be applicable to scenarios in which the mission area includes a plurality of observation areas 320, 330, each area having a respective observer 321, 331, and a plurality of transition areas 340 in overlapping areas of adjacent pairs of the observation areas 320, 330, without any significant alterations to the handover procedure or the optional implementation techniques discussed above.

It is assumed that the vehicle 110 will be configured to execute its mission by following a flight path 311 which moves the vehicle 110 through transition areas 340 to allow observation duties to be transitioned between observers 321, 331 and thus ensure at least one observer 321, 331 has visual contact with the vehicle at all times. In the event the mission is aborted and the vehicle 110 is to return to the base location 312, the vehicle 110 should be configured to return to the base location 312 via any transition areas 340 between the current vehicle position and the base location 312. This may be achieved by having the vehicle 110 determine a return to base flight path which ensures that the vehicle 110 will move between transition areas 340 in an appropriate manner to ensure that visual contact of the vehicle 110 can be maintained during the return to the base location 312.

In some examples, the vehicle 110 may be configured to return the base location 312 with regard to predefined “must-fly zones” and “no-fly zones” within the mission area 310. In more complex scenarios the vehicle 110 may be provided with an on-board path planner subsystem, especially if the vehicle 110 needs to strictly adhere to no-fly zones. In some examples, the return to base flight path may be determined using a visibility analysis tool using terrain maps to ensure the vehicle 110 stays within line of sight of the observers 321, 331 during its return flight.

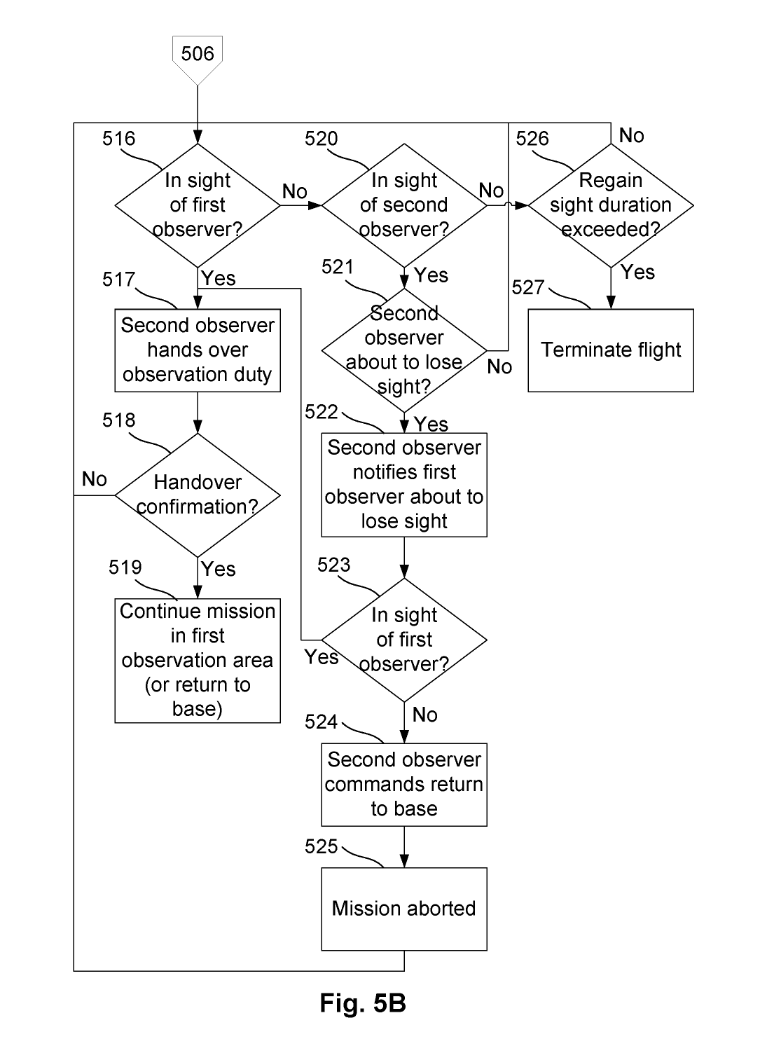

A more detailed example of a handover procedure will now be described with reference to the flowchart spanning FIGS. 5A to 5C to further illustrate a number of the above discussed optional aspects in practice.

This example commences in a similar manner as for the flowchart of FIG. 4, with the vehicle 110 executing its mission within the first observation area 320 at step 500, in sight of the first observer 321. The vehicle then enters the transition area 340 at step 501, and at step 502 the second observer 331 will check whether the vehicle 110 is in sight.

If the second observer 331 does indeed make visual contact with the vehicle 110 at step 502, the second observer 331 will typically confirm this to the first observer 321, usually by wireless voice communication, after which the first observer 321 hands over observation duty to the second observer 331 at step 503, again usually by wireless voice communication. In practice the first and second observers 321 may be in communication as the vehicle 110 approaches and enters the transition area to ensure the second observer 331 is prepared to acquire visual contact with the vehicle 110 such that the transition of observation duties can be as smooth as possible.

Assuming the handover has been confirmed to have been successfully completed at step 504, the vehicle 110 can continue its mission in the second observation area at step 505. However, if the handover is not confirmed, such as if the second observer 331 loses visual contact with the vehicle 110, and then the second observer 331 will continue to try to re-establish visual contact with the vehicle 110 at step 502.

Turning back to step 505 in which the vehicle 110 has continued its mission following a successful handover, in this example, once the vehicle 110 has executed the required part of its mission within the second observation area 330, the vehicle 110 will typically need to return through the transition area 340 as it returns to the base location 312, as indicated at step 506. This will trigger a further transition process at step 516 of FIG. 5B, which will be discussed in further detail in due course.

If at step 502 the second observer 331 does not make visual contact with the vehicle 110, the second observer 507 will typically notify the first observer 321 that the vehicle 110 is not in sight and the first observer 321 will then check whether the vehicle 110 is still in sight at step 507, which may be the case if the vehicle 110 had not yet exited the transition area 340 on its flight path 311 or if vehicle 110 can still be seen by the first observer 321 despite it having moved into the designated second observation area 330.

If the vehicle 110 is in sight of the first observer 320 at step 507, the first observer 321 will determine whether the vehicle 110 is about to move out of visual range of the first observer 321 at step 508 (i.e. the first observer 321 will check whether they are about to lose sight of the vehicle 110). If visual contact with the vehicle 110 is not about to be lost, then the second observer 331 will continue to try to re-establish visual contact with the vehicle 110 at step 502.

On the other hand, if the first observer 321 is about to lose sight of the vehicle 110 at step 508, the first observer 321 will notify the second observer 331 of this at step 509, and the second observer 510 will perform a final check as to whether the vehicle 110 is in their sight at step 510. If the second observer 331 is able to make visual contact with the vehicle 110 at step 510, then the method will proceed as per the above described case in which the vehicle 110 is in sight of the second observer 331 at step 502, in which case the first observer 321 hands over observation duty at step 503.

However, if the vehicle 110 is in sight of the first observer 321 but the first observer 321 is about to lose sight and the second observer has not been able to make visual contact at step 510, then the first observer 321 will command the vehicle 110 to return to the base location 312 at step 511 to ensure the vehicle 110 does not move out of sight of the first observer 321. This will typically involve the first observer 321 inputting a command using the remote user interface 120. In one example, this may be achieved by inputting an abort command using the remote user interface 120 as discussed above.

In any case, once the vehicle 110 has been commanded to return to the base location, the mission will be aborted at step 512. Once the mission has been aborted the vehicle 110 will return to the base location 312 in sight of the first observer 321, at step 513.

However, if the vehicle 110 is not in sight of the second observer 331 at step 502 or the first observer 321 at step 507, a predefined period of time may be allocated to allow visual contact to be restored by one of the observers 321, 331 before further action is taken. Accordingly, a check may be made as to whether a “regain sight duration” has been exceeded at step 514, and if not, the second observer 331 can continue to try to establish visual contact with the vehicle at step 502, but if the regain sight duration” has been exceeded at step 514, then one of the observers 321, 331 may terminate the flight of the vehicle 110 at step 515 to thereby prevent any further potentially unsafe flight without visual contact.

In some examples, if the vehicle 110 is not in sight of the second observer 331 at step 502 or the first observer 321 at step 507, a hover command may be input to cause the vehicle 110 to perform a hovering maneuver to assist the first observer 321 in acquiring visual contact with the vehicle 110. The hover command will typically be input by the first observer 321 using the respective remote user interface 120, but could alternatively be input by the second observer 331. In any event, the hover command should only be input if there is not air traffic within the two observation areas 320, 330 that may otherwise pose a collision risk if the vehicle 110 is caused to perform a hovering maneuver.

If, after hovering, the vehicle 110 comes in sight of the first observer 321, the first observer 321 may now safely command the vehicle 110 to return to the base location 312 in the sight of the first observer, through the first observation area 320, in a similar manner as described above for step 511. However, if the hovering vehicle 110 is not visible to the first observer 521, then this might indicate that the vehicle 110 has already travelled out of the visual line of sight or the visual range of the first observer 521, but may now be visible to the second observer 521 due to the hovering maneuver. Accordingly, the second observer 531 may check whether the hovering vehicle 110 is in sight. If this is the case, then the second observer 331 will confirm this to the first observer 321 and may abort the mission. This will cause the vehicle 110 to start its return to the base location while in the sight of the second observer 331.

In some implementations of the above discussed optional hovering behaviour, in the case that the vehicle 110 is not in sight of the first observer 321 or the second observer 331, the vehicle 110 may be allowed to hover and climb to a predefined altitude ceiling for a predefined hover duration. It will be appreciated that this hover duration may be the same as the regain sight duration at step 514 as mentioned previously. Whilst the hover duration has not expired, the observers 321, 331 may continue to check for visual contact with the vehicle 110. However, once the hover duration has expired at, the first observer 321 or the second observer 331 may terminate the flight of the vehicle 110 to thereby prevent any further potentially unsafe flight without visual contact, as per step 527 discussed above.

Ultimately, if the vehicle 110 does move through the transition area 340 with a successful handover of observation duties to the second observer 331, the vehicle 110 will need to return through the transition area 340 as indicated at 506, and this will trigger the need for another transition process beginning at step 516 of FIG. 5B.

This time, the transition of observation duties is from the second observer 331 to the first observer 321. At step 516, the first observer 321 will check whether the vehicle 110 is in sight, and if not, the second observer 321 will check whether the vehicle 110 is still in their sight at step 520.

If the second observer 321 can still see the vehicle, and does not believe the vehicle 110 is about to move out of their sight at step 521, then the first observer 321 can continue to check for visual contact with the vehicle at step 516. However, if the second observer 331 is about to lose sight of the vehicle 110 at step 521, then the second observer 331 will notify the first observer 321 that visual contact with the vehicle 110 is about to be lost at step 522. The first observer 321 will perform a final check on whether visual contact can be established at step 523, but if not, the second observer 524 should command the vehicle 110 to return to base at step 524, in a similar manner as discussed above for step 511. The mission will then be aborted at step 525, and the vehicle 110 will start to move towards the base location 312. It is noted that the observation duties will typically still need to be transitioned from the second observer 331 to the first observer 321 to allow the vehicle to proceed through the first observation area 320, in which case the return leg transition procedure will restart at step 516 as discussed above.

If the first observer 321 is able to successfully make visual contact with the vehicle 110 either in the initial check at step 516 or in the final check at step 523 after the second observer 331 is about to lose sight of the vehicle 110, then the first observer 321 will typically confirm to the second observer 331 that the vehicle 110 is in sight. The second observer 331 is then able to hand over observation duty to the first observer 321 at step 517, and once a successful handover is confirmed at step 518, the vehicle 110 can continue its mission in the first observation area or complete its return to the base location 312 (either as part of its mission or when returning after the mission has been aborted) in the sight of the first observer 321, as per step 519.

If neither observer 321, 331 is able to make visual contact with the vehicle 110 at steps 516 and 520, provided the regain sight duration is not exceeded at step 526, the observers 321, 331 may continue to check for visual contact with the vehicle 110. However, if the regain sight duration is exceeded at step 526 without visual contact by either observer 321, 331, then the flight of the vehicle will be terminated at step 527. The termination will usually be initiated by the first observer 321 since that individual will be responsible for the safety of the further flight of the vehicle 110 beyond the transition area 340 as the vehicle 110 returns to the base location 312.

In some examples, a hovering maneuver may also be initiated during step 526 by inputting the hover command using the remote user interface 120, to assist the observers 321, 331 in making visual contact with the vehicle 110. If the hovering vehicle 110 has not come into the sight of either observer 321, 331, the vehicle 110 may be allowed to hover for a predefined hover duration (which may be the same as the regain sight duration), but if visual contact cannot be made by the time the hover duration expires, then the flight of the vehicle may be terminated at step 527 as discussed above.

In another aspect, the unmanned aerial vehicle 110 may be configured to abort its mission or terminate its flight in response to a range of conditions beyond receiving commands from a remote user interface 120, to provide an enhanced safety capability.

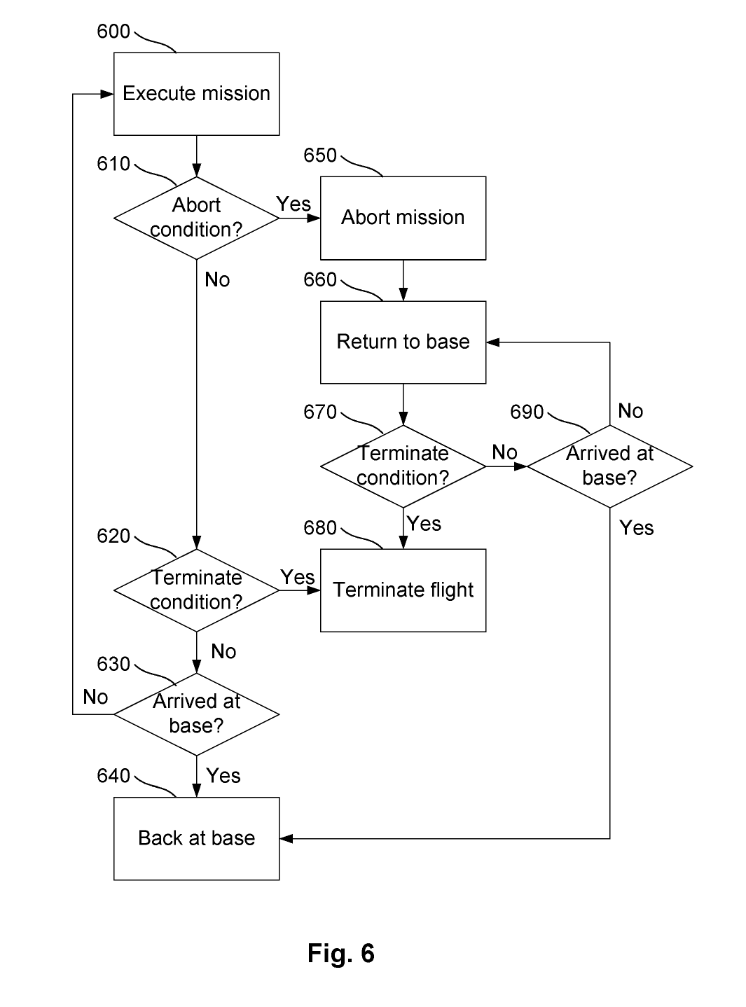

To illustrate this, an example of a method of controlling an unmanned aerial vehicle 110 executing a mission in a defined mission area 310, to allow the mission to be aborted or the flight to be terminated depending on conditions encountered by the vehicle 110, will now be described with reference to the flow chart of FIG. 6.

As discussed above, the vehicle 110 typically includes one or more processing systems 210 in wireless communication with one or more remote user interfaces 120. The method is implemented in the one or more processing systems 210 of the vehicle 110, typically by having the one or more processing systems 210 execute suitably configured software for performing the required functionalities to be described below.

The method commences with the vehicle 110 executing the mission at step 600. Typically, as the mission is being executed by the vehicle 110, the one or more processing systems 210 will periodically or continuously monitor a variety of different inputs in order to detect whether the vehicle 110 has encountered an abort condition at step 610 or a terminate condition at step 620. At a minimum, an abort condition or terminate condition may be detected based on at least one of a user command received from a remote user interface 120, or sensor data received from sensors of the vehicle 110, although other inputs may be used to detect conditions of the vehicle 110.

In the absence of an abort condition or a terminate condition, the detection steps 610, 620 will typically be looped as the vehicle 110 continues to execute its mission unless the vehicle is determined to have arrived at the base at step 630, which usually indicates that the vehicle 110 is safely back at the base location 312 as indicated at step 640. It is noted that a mission is typically not considered to be completed until the vehicle 110 has landed and the engine is shut down.

If an abort condition is detected at step 610, the method involves causing the vehicle 110 to abort the mission at step 650 and return to the base location 312 at step 660. As discussed above, the base location 312 will generally be within the mission area 310.

Whilst the vehicle 110 is returning to the base location 312 at step 660, the one or more processing systems 210 will continue to monitor inputs from the remote user interface or the sensor data to detect whether the vehicle 110 has subsequently encountered a terminate condition at step 670. In the absence of a terminate condition at step 670, the vehicle 110 will continue its return to base whilst monitoring for a termination condition is repeated, until it is determined that the vehicle 110 has successfully returned to the base location 312 at step 690.

It is not strictly necessary to monitor for further abort conditions at this stage since the mission will have already been aborted. However, in some examples, if a further abort condition is detected after the mission has already been aborted and the vehicle 110 is returning to the base location 312, then this may be indicative of more critical issues and be treated as a terminate condition rather than an abort condition.

In response to detecting a terminate condition at either step 620 or 670, the flight of the vehicle 110 will be terminated at step 680. As discussed above, termination will typically involve at least stopping the engine of the vehicle 110 to thereby cause the vehicle to go to ground as soon as possible, and thus prevent further flight of the vehicle 110 which could otherwise be unsafe in view of the existence of a termination condition.

It will be appreciated that the above described functionality for allowing the vehicle 110 to autonomously abort the mission or terminate flight can significantly improve the safety of unmanned operations, especially in extended visual line of sight operations where observers 321, 331 may only have visual contact with the vehicle 110 and limited control over the operation of the vehicle 110. These autonomous abort or terminate behaviours help to allow safe operations with simplified remote user interface 120 configurations.

An abort condition may be encountered in the event of either receiving an abort command from a remote user interface 120 in communication with the one or more processing systems 210, or detecting, based on the sensor data, a non-critical issue that will inhibit execution of the mission. It will be appreciated that the execution of the mission could be inhibited in a range of different circumstances. For example, the non-critical issue may include a low fuel level, a low battery charge level, an engine warning, a mission equipment malfunction, entering a geofence buffer zone (an area defined by a geofence surrounding the mission area and another fence following the geofence inside the mission area), deviation from a vehicle flight envelope, or an excessive trajectory tracking error.

In the case of a low fuel level, this may be detected by determining that a fuel level is below a predetermined fuel level threshold, or in more sophisticated embodiments, determining that the fuel level is insufficient to complete the mission, which may involve calculating the remaining range based on predefined or sensed fuel consumption data and comparing this with the distance remaining to be travelled along the flight path 311 in order to complete the mission.

In the case of a low battery charge level, this may be detected, for instance, by determining that a battery charge level is below a predetermined battery charge threshold.

The detection of engine warnings or mission equipment malfunctions will typically depend on the respective configurations of the engine or mission equipment subsystems and may rely on these providing specific outputs to the one or more processing systems 210 of the vehicle in the event of an error/malfunction.

Deviation from the flight envelope may be detected by monitoring flight parameters of the vehicle 110 and determining whether these are outside predefined vehicle flight envelope parameters. Examples of flight parameters include velocity, altitude, angle of attack, and load factors due to maneuvers. It will be appreciated that combinations of these flight parameters may be considered in this determination. When flight parameters of the vehicle 110 are outside the flight envelope parameters, this may indicate, for example, that the vehicle 110 has encountered a malfunction compromising the flight of the vehicle or has encountered extreme weather conditions or the like. It may be preferable to abort the mission in these circumstances rather than risk damage to the vehicle 110 due to loads that exceed design parameters or potentially unsafe operation of the vehicle 110.

An excessive tracking error may be encountered if the vehicle 110 fails to follow the flight to a sufficient degree of accuracy, and may be indicative of a malfunction in the flight control of the vehicle 110 or disturbances due to wind or the like that cannot be countered within the capabilities of the vehicle 100. An excessive tracking error may be detected by determining that a tracking error is greater than a predetermined tracking error threshold. This determination will usually be performed in the guidance module based on sensor data indicative of the vehicle position, velocity, altitude and the like.

A terminate condition may be encountered in the event of either receiving a terminate command from a remote user interface 120, or detecting, based on the sensor data, a critical issue that will prevent safe operation of the vehicle 110.

It will be appreciated that a range of different circumstances may be deemed to have a sufficient safety impact so as to qualify as a critical issue terminate condition. For instance, a critical issue may include the vehicle 110 leaving the mission area 310, a loss of a global positioning system (GPS) signal, a loss of wireless communication with the remote user interface units 120, an unrecoverable malfunction of an avionics system of the vehicle, or a failure of a critical sensor of the vehicle 110.

Other examples of critical issues may include a failure of a flight computer of the vehicle, a failure of an inertial measurement unit (IMU) of the vehicle, a failure of an attitude and heading reference system (AHRS) of the vehicle, or a failure of an electric power system of the vehicle.

IMU and AHRS will typically be critical systems such that their malfunction should lead to flight termination. With regard to the AHRS, in some implementations, a failure may be detectable when data is not received from the AHRS without transmission errors within a given time. With regard to the flight computer, in some implementations the flight computer may produce a heartbeat signal, such that if the heartbeat signal is not received within a given time flight termination will be activated.

When the vehicle leaves the mission area 310 this will usually mean there has been a failure in the guidance, navigation (state estimation) or control of the vehicle 110, or the vehicle 110 has encountered extreme weather conditions such as strong gusts or updrafts that cannot be compensated to allow execution of the mission. Leaving the mission area 310 will usually be considered a safety critical event, especially if the mission area 310 is located close to populated areas or areas with other air traffic.

The mission area 310 will typically include a perimeter defined by a series of perimeter coordinates, such that it will be possible to detect whether the vehicle 110 has left the mission area 310 by comparing the position of the vehicle 110, obtained using a global positioning system or the like, to the perimeter coordinates. An altitude ceiling will typically also be established for the mission area 310, and this may be an absolute maximum altitude or a location dependent maximum altitude. The vehicle 110 may also be deemed to have left the mission area 310 if the altitude of the vehicle 110 exceeds the applicable altitude ceiling.

A loss of a global positioning system signal may be considered to have a similar level of safety risk as leaving the mission area 310 because the vehicle 110 may no longer be able to maintain its flight path or determine whether it is still within the mission area 310 without positioning data.

If wireless communication with the remote user interface units 120 is lost, this removes the capability of the observers 321, 331 to manually cause the vehicle 110 to abort the mission and return to the base location 312, or terminate the flight of the vehicle 110 in response to an observed risk of collision with other air traffic. This therefore represents the loss of a significant safety capability and continued operation of the vehicle 110 without wireless communication with the remote user interface units 120 such that automatic termination of flight may be warranted.

In operations involving two observers 321, 322 each having their own remote user interface unit 120, as per the examples above regarding the transition of observation duties, a loss of wireless communication for only one remote user interface unit 120 would not typically necessitate require termination since it may be assumed that an observer 321, 331 can still communicate with the other observer 321, 331 using wireless voice communications to request that an abort command or a terminate command be input in the event that this is not possible to input directly due to a loss of wireless communication for their remote user interface unit 120. In implementations involving a plurality of observers 321, 322, similar reasoning may apply, and a terminate condition may only be detected when wireless communications are lost for every one of the remote user interface units 120.

Avionics systems of the vehicle 110 will typically be critical to the continued safe flight of the vehicle 110, and therefore when an unrecoverable malfunction is detected in one of the avionics systems this may be interpreted as a critical issue and thus trigger a terminate condition.

Similarly, a failure of a critical sensor of the vehicle 110 may also be detrimental to the continued safe flight of the vehicle 110. Critical sensors may include, for example, a pressure altimeter of the vehicle 110, a positioning sensor of the vehicle 110, or a radar sensor of the vehicle 110.

In preferred embodiments, the vehicle 110 will include an obstacle detection sensor 140 which may be used to provide the vehicle with obstacle avoidance functionalities. Accordingly, in some examples, the method discussed above with regard to FIG. 6 may include detecting an abort condition when the obstacle detection sensor 140 detects an object ahead of the vehicle 110, while the vehicle 110 is executing the mission. As a result, the vehicle 110 will be capable of detecting an object that may present a risk of collision and responding by automatically aborting its mission and returning to the base location 312.

On the other hand, in some implementations, a terminate condition may be detected when the obstacle detection sensor 140 detects an object ahead of the vehicle 110 while the vehicle 110 is returning to the base location 312 after the mission has been aborted. Accordingly, the vehicle 110 may respond to detecting an object in different manners depending on the current flight mode of the vehicle 110.

It should be noted that detecting an obstacle during the return flight is not necessarily a safety critical event, and in other implementations the vehicle 110 may be configured to attempt clear an obstacle by climbing or hovering and resuming the return flight. If the vehicle 110 encounters the same obstacle again, then flight termination can be activated. As will be discussed in further detail below, the vehicle 110 may also include a terrain following system for providing the functionality of detecting forward obstacles and avoiding them by climbing, in which case flight termination may not need to be activated in these situations. Flight termination might be activated if obstacles are detected with some small pre-set distance threshold that is different/smaller from the one used during normal obstacle avoidance mode.

It should be appreciated that the autonomous flight of the vehicle 110 during the execution of the mission or during a return to the base location 312 after the mission has been aborted may be handled through the coordinated operation of a guidance module and a flight control module, each provided by the one or more processing systems 210. The guidance module will typically be configured for generating flight commands and the flight control module will typically be configured for controlling flight of the vehicle 110 based on the flight commands.

The guidance module may have different behaviour depending on the detection of conditions as discussed above. For instance, in the absence of an abort condition or a terminate condition, the guidance module may generate flight commands for causing the vehicle 110 to execute the mission according to a predefined mission flight plan. On the other hand, if an abort condition has been detected, the guidance module may generate flight commands for causing the vehicle 110 to return to the base location 312. In some examples, this may merely involve causing the vehicle 110 to return to the base location 312 following a direct trajectory.

However, in other examples, in response to detecting an abort condition, the guidance module may generate a more sophisticated return to base flight plan for returning the vehicle 110 from a current vehicle position to the base location. This may be required to ensure the vehicle 110 remains within the mission area 310 or to account for known obstacles within the mission area 310.

In particular embodiments in which the mission area 310 includes first and second observation areas 320, 330 and a transition area 340 in an overlapping area of the first and second observation areas 320, 330 as discussed above, the method will preferably include having the guidance module generate the return to base flight plan so that the vehicle 110 returns to the base location 312 via the transition area 340. This can ensure that observation duties can be transitioned between observers 320, 330 as required during the return of the vehicle to the base location 312.

If the mission area 310 includes a plurality of observation areas 320, 330 and a plurality of transition areas 340 in overlapping areas of adjacent pairs of the observation areas 320, 330, the guidance module may generate the return to base flight plan so that the vehicle 110 returns to the base location 312 via any transition areas 340 between the current position of the vehicle 110 and the base location 312. The guidance module may be configured to generate the return to base flight plan to take a shortest path via the transition areas 340 or to take a path via a minimum number of transition areas 340, depending on requirements.

As mentioned previously, each remote user interface 120 may include a command input 121 for allowing a user to input an abort command and a kill switch 122 for allowing a user to input a terminate command. The vehicle 110 may be configured to perform a maneuver in response to activation of the command input depending on a duration of the activation, a current flight mode of the vehicle 110, or a number of activations in a defined time period. For instance, the vehicle 110 may perform a ducking maneuver in response to a short activation of the command input or perform a hovering maneuver in response to a long activation of the command input. These types of command inputs for causing maneuvers may not necessarily be interpreted as an abort condition. However, the vehicle 110 may interpret activations of the command input as an abort command in particular conditions, such as in the event of a long activation of the command input when the vehicle 110 is performing a hovering maneuver.

In a further aspect, the unmanned aerial vehicle 110 may be specifically configured to allow a single radar sensor 141 to be used in different radar orientations in different flight modes, such as to enable obstacle avoidance behaviours as discussed above or other behaviours such as terrain following, hovering at a controlled height above terrain, etc.

With regard to FIG. 1, the vehicle 110 may include a radar sensor 141 mounted on the vehicle 110 using a moveable mount 142 for moving the radar sensor 141 between different radar orientations, as indicated by the arrow 101. The different radar orientations may include two or more discrete radar orientations or a continuous range of radar orientations. The radar sensor 141 generates a range signal using conventional radar techniques.

The one or more processing systems 210 of the vehicle may be configured to provide a mount control module for controlling the moveable mount 142 to move the radar sensor 141 into one of the radar orientations based on a current one of a plurality of flight modes, and a flight control module for controlling flight of the vehicle 110 using the range signal, based on the current flight mode.

It will be appreciated that the use of different radar orientations depending on the flight mode and the use of the generated range signal based on the particular radar orientation in the control of flight of the vehicle within the current flight mode can allow a single radar sensor 141 to be advantageously used in a range of different ways. In preferred embodiments, this arrangement may facilitate particular modes of flight that are especially useful in extended visual line of sight operations of unmanned aerial vehicles 110.

Examples of flight modes and the differently radar orientations that may be used together with how the correspondingly different range signals are used by the flight control module will now be outlined.

For instance, the plurality of flight modes may include an obstacle avoidance mode, in which the mount control module causes the moveable mount 142 to move the radar sensor 141 into an obstacle avoidance orientation in which the range signal is indicative of a distance between the vehicle 110 and any object in a flight direction of the vehicle 110. In this case, the flight control module may be configured to initiate at least one obstacle avoidance measure if the range signal falls below an obstacle avoidance range threshold. It will be appreciated that this can enable the obstacle avoidance behaviour discussed above in the context of detecting abort or terminate conditions.

The obstacle avoidance orientation will typically be selected to allow objects in the flight direction of the vehicle 110 to be readily detected, and may point the radar sensor in a substantially forward direction relative to the vehicle 110, for forward flight, or in some examples, in a direction that is substantially aligned with the flight direction of the vehicle 110 to account for directions of flight other than forward.

The particular obstacle avoidance measure or measures initiated in response to detection of an object may vary depending on requirements such as whether deviations from the flight path 310 are permitted while executing a mission or the flight capabilities of the vehicle 110. For example, the obstacle avoidance measure may include causing the vehicle 110 to perform one, or a combination of, the following actions: hover, climb in altitude, attempt to steer around an object, abort the mission, or return to the base location 312.

In some specific examples, the obstacle avoidance measures may cause the vehicle 110 to decelerate to a stop (ideally at a sufficient rate of deceleration to prevent collision with the object) then automatically return to the base location 312. The return to the base location 312 may be performed at an increased altitude compared to the altitude of the vehicle 110 during the execution of the mission, and therefore after stopping the vehicle 110 may climb in altitude prior to commencing its return to the base location 312. This can help to avoid the need to navigate the vehicle 110 around the detected object. For instance, if the object is an unexpected tree in the flight path 310 of the vehicle 110, it may be most expedient to simply have the vehicle 110 climb vertically until the tree is no longer detected ahead of the vehicle rather than attempt to fly around the tree, especially if the tree obstructs the most direct path for returning to the base location 312.

Additionally or alternatively, the obstacle avoidance measures may cause the current flight mode of the vehicle 110 to transition from the obstacle avoidance mode to a different one of the plurality of flight modes. For example, in the event that detection of an object triggers the vehicle 110 to return to the base location 312, the vehicle 110 may transition to another flight mode which is better suited to returning to the base location 312 along a return to base path that has not been previously defined in the same manner as the mission flight path 311. For instance, a terrain following mode may be used so that the vehicle maintains a separation from terrain rather than following a predefined flight path 311 and scanning for objects ahead of the vehicle 110.

In some embodiments, the obstacle avoidance mode will be activated by default as the current flight mode when the vehicle 110 is executing a mission. As discussed above, the mission usually involves flight along the predefined flight path 311 which will typically be established with familiarity of the terrain and taking account for any known obstacles in the mission area 310. The flight path 311 will usually define the altitude of flight in accordance with the local terrain and the obstacle avoidance behaviour will typically only be required in the event of unexpected objects in the flight path 311.

With regard to the above mentioned obstacle avoidance range threshold, although this may simply be a predetermined threshold that applies throughout all flight of the vehicle 110, in some examples it may be desirable to determine the obstacle avoidance range threshold dynamically, for instance based on a flight speed of the vehicle 110 and/or a flight direction of the vehicle. Accordingly, the obstacle avoidance range threshold may be adjusted to account for the likelihood of collision and the time within which a collision might occur, to ensure, for example, that the vehicle 110 is capable of stopping before a collision.

As mentioned above, the plurality of flight modes may also include a terrain following mode, in which the mount control module causes the moveable mount 142 to move the radar sensor 141 into a terrain following orientation in which the range signal is indicative of a distance between the vehicle 110 and terrain ahead of the vehicle 110, and the flight control module causes the vehicle 110 to maintain at least a minimum separation from the terrain based on the range signal.

It will be appreciated that the flight control module may utilise the range signal in a different manner in the terrain following mode compared to the obstacle avoidance mode. In particular, in the terrain following mode, the flight of the vehicle 110 may be continuously controlled based on the range signal to maintain the minimum separation from the terrain, whereas in the obstacle avoidance mode, the flight of the vehicle 110 may continue without any control specifically based on the range signal provided an object is not detected ahead of the vehicle 110. The vehicle 110 only responds to the range signal when an object is detected. It will be understood that different orientations of the radar sensor 141 will be more advantageous in these different flight modes.

In some embodiments, the terrain following orientation points the radar sensor 141 in an angled direction that is rotated downwardly from a forward direction relative to the vehicle 110, to thereby allow the radar sensor 141 to detect the terrain ahead of the vehicle 110 and any object in a flight direction of the vehicle. This can be contrasted with the obstacle avoidance orientation which generally points the radar sensor 141 forward or in the flight direction of the vehicle 110.

The angled direction of the terrain following orientation may be rotated downwardly from the forward direction by an angle of between 30 degrees and 60 degrees. In one specific embodiment, the angled direction may be rotated downwardly from the forward direction by an angle of approximately 45 degrees. In any event, by selecting the terrain following orientation to point the radar sensor 141 at an intermediate angle between a forward direction and a downward direction this can provide a range signal that represents the distance to a region of terrain that the vehicle 110 is about to travel over, to thereby allow the flight control module to control the flight of the vehicle 110 accordingly to maintain the minimum separation from the terrain as the vehicle 110 actually travels over that region of terrain.

In particular embodiments, whilst the flight control module is in the terrain following mode, the flight control module may cause the vehicle 110 to maintain at least the minimum separation from the terrain by controlling an altitude of the vehicle 110 above the terrain. In some implementations of this behaviour, the flight control module may control the altitude of the vehicle 110 between a maximum altitude limit and a minimum altitude limit that provides the minimum separation from the terrain. In some examples, the flight control module may be configured to increase the altitude of the vehicle when the range signal falls below a terrain following range threshold. However, the flight control module would not necessarily decrease the altitude of the vehicle unless the maximum altitude limit was reached. This can help to enable more efficient flight without constant altitude changes in undulating terrain.

During the terrain following mode, the flight control module may also regulate the ground speed of the vehicle 110 depending on a number of factors, and in some embodiments the ground speed is regulated based on the range signal. During this mode, the vehicle 110 can also avoid some frontal obstacles by performing climbs (sloped or vertical depending on the obstacle and its distance). It will be appreciated that adjustment of the ground speed may be required to maintain the vehicle 110 between the minimum and maximum altitudes when flying over steep positive or negative slopes. As the vertical speed of the vehicle 110 is limited, the system may need to reduce the ground speed of the vehicle 110 to give it time to climb or descend to a desired altitude.

It should also be noted that the terrain following mode may allow the vehicle 110 to avoid not only terrain but also obstacles (tall trees, towers, buildings) that might be present along the return to base route/path. This may be achieved by steps of: detecting these vertical obstacles in addition to terrain using heuristics, reducing the vehicle ground speed (potentially to zero depending on the distance and height of the obstacle) while increasing the climb speed, judging that the obstacle has been cleared and starting a sloped descent to the desired height above terrain.

In some examples, the terrain following mode may be activated as the current flight mode by default when the vehicle 110 has aborted the mission and is returning to the base location 312. Accordingly, if the obstacle avoidance mode is the default flight mode while the vehicle 110 is executing a mission, the current flight mode may transition from the obstacle avoidance mode to the terrain following mode when an object is detected by the radar sensor 141 and the mission is aborted as the obstacle avoidance measure.

However, it should be noted that the terrain following mode may also be used in other situations. For example, it can also be used to allow the vehicle 110 to travel to a particular region of the mission area, such as a predetermined survey area in an aerial surveying mission, particularly if no accurate terrain models are available for the transit flight. The reason why terrain following may not be generally used during parts of the mission, such as during surveys, is that flight may be required at a given altitude and speed that may not be safe in the terrain following mode. Accordingly, following a predefined mission flight path in the obstacle avoidance mode may be preferred for safety reasons.

In some examples, the plurality of flight modes may include a vertical flight mode, in which the mount control module causes the moveable mount 142 to move the radar sensor 141 to an altimeter orientation in which the range signal is indicative of an altitude of the vehicle 110 above terrain beneath the vehicle 110, and the flight control module controls vertical flight of the vehicle 110 based on the range signal. It will be appreciated that the vertical flight mode may be useful during a range of different maneuvers the vehicle 110 may perform, including take-off, landing, hovering, ducking, and altimeter adjustment maneuvers. It is noted that vertical flight modes will mainly be applicable to vehicles 110 capable of vertical or hovering flight, such as rotary wing aircraft including helicopters, quadrotor aircraft, or the like.

The altimeter orientation will preferably point the radar sensor 141 in a downward direction relative to the vehicle 110, to thereby allow the radar sensor 141 to detect the terrain directly beneath the vehicle 110. It will be appreciated that the altimeter orientation can also provide obstacle detection in the direction of flight of the vehicle during maneuvers involving vertical descent, such as the ducking maneuver. During a ducking maneuver, the flight control module may cause the vehicle 110 to descend until the range signal reaches a ducking range threshold.

In some implementations, the flight control module may use the range signal in the vertical flight mode to determine a height above ground estimation. This height above ground estimation may be used, for example, to adjust a pressure altimeter of the vehicle. This may involve the use of an altimeter adjustment maneuver as mentioned above, to automatically adjust the pressure altimeter for normal flight and for landing maneuvers. Correct altitude readings are also important if altitude needs to be reported to other aircraft. The altimeter adjustment maneuver may involve performing a descent maneuver and measuring height above ground with known elevation using the radar sensor 141 pointing down. It is noted that incorrect altitude readings of the pressure altimeter are caused by expected changes of atmospheric pressure at a reference point. Any difference between the altitude readings obtained from the pressure altimeter and the radar sensor 141 (which is not subject to atmospheric condition changes) can be accounted for by adjusting the pressure altimeter accordingly.

In one example, the flight control module may also use the range signal in the vertical flight mode for initialisation of the terrain following mode. The radar sensor 141 may be pointed down and the vehicle 110 may descend or climb vertically until reaching the desired height above terrain for the terrain following mode (such as 60 m in some embodiments). The radar sensor 141 may then be moved into the terrain following orientation to allow the terrain following mode to be carried out as discussed above.

In some examples, the mount control module may be configured to control the moveable mount 142 to move the radar sensor 141 into one of the radar orientations based on a velocity of the vehicle 110 and/or an altitude of the vehicle 110. This can allow enable selection of the most appropriate radar orientation depending on current flight parameters, in addition to or even instead of referring to the current flight mode. As mentioned above, the radar sensor 141 may be moveable throughout a continuous range of orientations, and the specific orientation may be selected based on the velocity and/or the altitude of the vehicle 110.

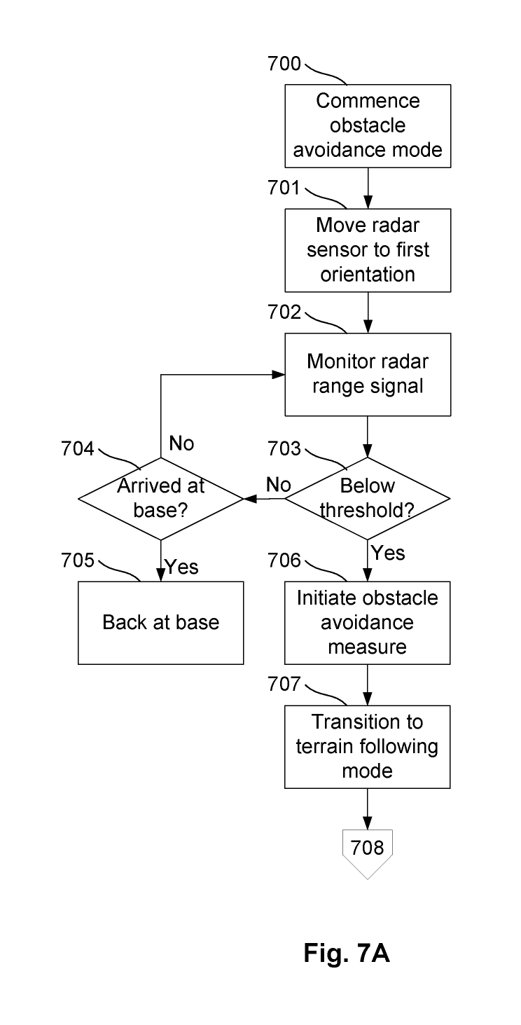

An illustrative example of movement of the radar sensor depending on the current flight mode and the flight control modules use of the resulting range signal will now be described with reference to FIGS. 7A and 7B. For the sake of simplicity, this example only considers the obstacle avoidance mode and the terrain following mode, although it should be understood that the example can be extended to include additional flight modes such as the aforementioned vertical flight mode.

This example is assumed to begin at step 700 when the obstacle avoidance mode is commenced, for instance once the vehicle 100 has taken off and has begun executing its mission by following a mission flight path 310 in forward flight. In step 701 the mount control module 142 will move the radar sensor 141 to a first orientation, namely an obstacle avoidance orientation as discussed above. Flight of the vehicle 110 will continue with the radar sensor 141 in the obstacle avoidance orientation and the radar range signal will be periodically or continuously monitored at step 702.

If the range signal is not determined to be below an obstacle avoidance range threshold at step 703, then provided the vehicle 110 has not arrived at the base location 312 (i.e. the mission is not yet completed) at step 704, then the flight of the vehicle 110 and monitoring of the range signal in the obstacle avoidance mode will continue from step 702. If the vehicle has arrived at base at step 704 without encountering an object, then usually this will mean that the vehicle 110 has completed its flight path 310 and is back at the base location 312 as indicated at step 705.

However, in the event that the range signal is determined to be below the obstacle avoidance range threshold at step 703, then the flight control module will respond by initiating one or more obstacle avoidance measures at step 706. As discussed above, the obstacle avoidance measures may involve aborting the mission and causing the vehicle 110 to return to the base location 312, and this may also automatically trigger a transition of the current flight mode to the terrain following mode at step 707.

When the terrain following mode is initiated either as a result of an obstacle avoidance measure at step 707 or some other input (such as an observer 321, 331 inputting an abort command to cause the vehicle 110 to abort the mission and return to the base location 312, activating the terrain following mode by default as discussed above), the terrain following mode commences at step 708. In response, at step 709 the mount control module moves the radar sensor 141 to a second orientation, namely a terrain following orientation as discussed above.

Whilst the terrain following mode is the current flight mode and the radar sensor 141 is in the terrain following orientation, the radar range signal is monitored at step 710 and the flight control module controls the altitude (and optionally the ground speed) of the vehicle 110 based on the range signal at step 711. The monitoring at step 710 and altitude (and optionally ground speed) control at step 711 will loop until it is determined that the vehicle 110 has arrived at the base location 312 at step 712, and this example ends with the vehicle back at the base location 312 at step 713.

It is noted that, at any point in the above described example, the vehicle 110 may receive a user command for causing the vehicle 110 to perform a maneuver such as ducking or hovering, thereby transitioning the current flight mode to a vertical flight mode. In that case, the radar sensor 141 may be moved to a third orientation, namely the altimeter orientation which points the radar sensor 141 downwards to allow the flight control module to control the altitude of the vehicle 110 directly based on the range signal.

In preferred embodiments of the above discussed method, when a frontal obstacle is detected in the obstacle avoidance mode, the vehicle 110 may be first commanded to brake and once the vehicle 110 is hovering the terrain following mode may be started. In some examples, activation of the terrain following mode may involve two main states of climbing/descending to a predetermined altitude, such as 60 m above ground level (AGL), with the radar sensor 141 pointing down in the third orientation, (i.e. the altimeter orientation), and then commencing forward flight in the terrain following mode with the radar sensor 141 in the second orientation (i.e. the terrain following orientation).

In any event, it will be appreciated that the use of the moveable radar sensor 141 arrangement together with the capability of the flight control module to control the flight of the vehicle 110 in different manners depending on the flight mode and orientation of the radar sensor 141 can allow for a single radar sensor 141 to be utilised in scenarios that may have traditionally required multiple different sensors. This can enable a reduction of the number of sensors provided on the vehicle 110 without compromising the operational capabilities of the vehicle 110, which can result in savings in terms of cost, weight and complexity.

The above described techniques using a moveable radar sensor 141 arrangement which is coupled with the flight control of the vehicle 110 may facilitate the use of an approach that considers a full perception-action loop that allows a single low-cost and reliable sensor to ensure the vehicle's safety and survivability in a number of flight modes and maneuvers/situations. This approach considers tight coupling between perception and action, in the sense that the radar sensor 141 is pointed in a specific direction depending on the flight mode of the vehicle 110, but also that the flight modes are configured so that flight trajectories of the vehicle 110 are controlled in a way that ensure that the vehicle 110 does not fly blind.

This approach may ensure that the vehicle 110 never flies blind (i.e., always flies in areas that are cleared by radar) by pointing the radar sensor 141 in an appropriate direction based on the flight mode, but also facilitates improvements in the way the guidance, navigation and control (GNC) system of the vehicle “flies” and “monitors” the vehicle (e.g. by limiting sloped descents, heading offsets in coordinated turns, and using primitives-based GNC that allows continuous accurate control of the vehicle state and heading, and the like).

For example, during sloped descent, the guidance and control systems of the vehicle may limit the path slope to an appropriate value based on feedback from the radar sensor 141. In another example, during coordinated turns, a heading offset may be automatically calculated and used to point the vehicle 110 in a particular heading to allow the radar sensor 141 to scan to-be-flown areas.

It will be appreciated that actuating a low-cost limited field-of-view radar sensor 141 in a closed-loop approach to detect obstacles in all maneuvers without continuously moving the radar is advantageous. By not continuously moving the radar sensor 141, this decreases the risk of actuator failure and sensor cable failures and provides for more cost-effective, lower power and possibly lower weight actuators.

As discussed in the above examples, the unmanned aerial vehicle 110 will preferably be provided as part of a system 100 further including remote user interfaces 120 in wireless communication with the vehicle 110, for allowing respective users, such as observers 321, 331, to input commands to the vehicle 110 such that the vehicle responds accordingly. In some embodiments, the remote user interfaces 120 may include only two inputs in the form of a command input 121 and a kill switch 122.

Specific examples of the behaviour of the system 100 in response to particular inputs using one of the remote user interfaces 120 will now be described with regard to the state machines depicted in FIGS. 8, 9 and 10.

It should be understood that each state machine includes one or more states of the vehicle 110 and the transitions between states are represented by transition lines. Each transition line has a direction as indicated by an arrow head and is labelled with the name of an event that triggers the transition represented by that transition line. In some cases, the transition line is also labelled with further text following a forward slash, which describes an action or output that occurs as part of the transition.

In this regard, it is noted that the remote user interfaces 120 may include a user feedback device such as a speaker, buzzer or the like which allows feedback to be provided to the user in the form of sounds or vibrations, which may be pulsed or repeated to represent different outputs. In this example, the remote user interfaces 120 are assumed to include speakers capable of outputting beep sounds, and thus the actions described for some outputs may include one or more beeps (“beep”, “doubleBeep”, “tripleBeep”, or “quadrupleBeep”) which can communicate different information to the user. In some instances a beep of a longer duration (“longBeep”) may be output to provide different feedback, such as the event of a failure.

With regard to the state machine depicted in FIG. 8, this represents the operation of the system 100 in response to activations of the command input of one of the remote user interfaces 120. The command input may be activated using a short push (indicated as a “shortPush” event on transition lines) or using a long push (indicated as a “longPush” event on transition lines), with different transitions occurring depending on whether a short or long push is input in some states.

It is noted that the use of a long push of the command input may be desirable over the use of a double push (i.e. multiple activations within a defined time period) or the like, since the short push (i.e. single activation without significant hold time) command will preferably be a high priority command which should be transmitted with minimum latency. Using duration as identifier, the command is identified once the button is released. However, with multiple activations, one has to wait a certain amount before it is clear which command has been input. Nonetheless, multiple activations may be used in other implementations.

The initial state of the vehicle 110 is typically the “engine off” state 801, with the only transition from this state being due to the engine being started as indicated by the “engineStart” event, leading to the “engine running on ground” state 802. The “engineStart” event may occur due to a user manually starting the engine by a direct input on the vehicle 110, by a pilot inputting a start engine command using a remote controller 130, or in some examples by having a user push the command input of the remote user interface 120 while the vehicle 110 is in the “engine off” state 801.

When a “shortPush” is input in the “engine running on ground” state 802 the system will output a prompt (“requestMode” event) for requesting whether the system 100 is to operate in a testing mode or a flight mode, and then transition to an intermediate state 803 prior to transitioning to one of two “waiting” states 805, 806 depending on whether the system 100 is determined to be in a test mode (“testMode” transition) or a flight mode (“flightMode” transition).

In the event the system 100 is in the test mode, a “doubleBeep” will be output during the transition to the “waiting” state 806, and a further “shortPush” input will transition to the “testing” state 804, accompanied by a “beep”. System tests will be performed in the “testing” state 804 with transitions from this state to the “engine running on ground” state 802 being triggered either due to a “failure” event indicating that an error has occurred in the testing (accompanied by a “longBeep”) or a “completed” event indicating that the testing has completed successfully (accompanied by a “tripleBeep”). On the other hand, the input of a further “shortPush” will be treated as a user command for aborting the testing, causing the system 100 to exit the “testing” state 804 and subsequently shut down the engine such that the system 100 reverts to the “engine off” state 801. This transition will be accompanied by another “beep” to confirm the abort of the testing to the user.

In the event the system 100 is in the flight mode, a “beep” will be output during the transition to the “waiting” state 805, and a further “shortPush” input will transition to the “take off” state 807 which will involve a take off procedure for causing the vehicle 110 to attempt to take off from the ground, accompanied by another confirmatory “beep”. However, if no input is received in this “waiting” state 805 within a timeout period of 8 seconds (“8 s timeout” event) the engine of the vehicle 110 will be stopped so that the vehicle 110 returns to the “engine off” state 801.

If an error (“error” event) is encountered in the “take off” state 807, then this will cause a transition to the “engine off” state 801, with the transition being accompanied by a “longBeep” output. It should be noted that the “engine off” state involves an engine shutdown procedure which will end with the engine being shut down, but may include an initial cooling period to prevent engine damage. Accordingly, a system error (such as a GPS failure or the like) whilst the vehicle 110 is still on the ground shortly prior to or during the take off procedure will ultimately result in the shut down of the engine of the vehicle 110. Alternatively, the user may manually abort a take off while the vehicle 110 is still on the ground in the “take off” state 807 using a “shortPush” input. This also triggers a transition to the “engine off” state 801 as discussed previously, but in this case the transition will be accompanied with a single “beep” to differentiate the transition from the “error” event transition. In some implementations, the detection of an error or an abort command input could alternatively cause a return to the “engine running on ground” state 802, to allow a the take off procedure to be retried without shutting down the engine. However, if a situation arises requiring the take off to be aborted this usually means there is a serious problem and therefore it is preferable to not provide an option to retry the take off.

Otherwise, if the take off procedure is successful, the vehicle 110 will become airborne (“airborne” event) which may be detected using a sensor for determining whether weight is currently on the landing gear 111 of the vehicle 110. Upon becoming airborne, the vehicle 110 will transition to the “normal flight” state 808.

The vehicle 110 will typically execute its mission in the “normal flight” state 808, which will usually involve forward flight of the vehicle following a mission flight plan 310, typically in an obstacle detection mode. Successful execution of the mission will culminate in the arrival of the vehicle 110 at the base location 312 (“arrived” event), resulting in a transition from the “normal flight” state 808 to a first “landing” state 812. As the vehicle 110 approaches the ground (“closeToGround” event), which may be determined using the radar sensor 141 in the altimeter orientation during the vertical flight mode of the vehicle 110, there will be a transition to a second “landing state” 813, and finally when touch down of the vehicle 110 on the ground takes place (“touchDown” event), the vehicle 110 will have returned to the “engine running on ground” state 802.

However, the landing procedure in the “landing” state 812 can be aborted by inputting a “shortPush” which will be confirmed with a “beep” output, thereby transitioning the vehicle to a “climbing” state 814 in which the vehicle 110 regains altitude and repositions itself for landing if the vehicle 110 has moved away from the base location 312. When the vehicle 110 has once again arrived at the base location 312 (“arrived” event), the vehicle 110 will transition to a “hovering” state 815 to await further confirmation to reattempt landing. A “shortPush” input will once again trigger a transition to the “landing” state 812

The vehicle 110 may be caused to exit the “normal flight” state 808 by the occurrence of an error (“error” event) which will transition the vehicle to a “returning” state 811 in which the vehicle 110 aborts the mission and returns to the base location 312. It will be appreciated that this behaviour may represent an example of the vehicle 110 encountering an abort condition as discussed above.

Alternatively, the user may input commands to cause the vehicle 110 to exit the “normal flight” state 808. In the event of a “shortPush” input, the vehicle 110 transitions to a “ducking” state 810 in which the vehicle 110 performs a ducking maneuver as discussed above, which is confirmed with a single “beep” output. In some circumstances, if the vehicle 110 has already arrived at the base location 312 (“arrived” event) when the “ducking” state 810 is initiated, the vehicle 110 may transition to the “landing” state 812.

The vehicle 110 may transition from the “ducking” state 810 to the “hovering” state 809 when a “longPush” input is entered. Similarly, a “longPush” input may cause the vehicle 110 to transition from the “normal flight” state 808 to the “hovering” state 809. In either case, the “longPush” input will be accompanied with a “doubleBeep” output to confirm the transition to the “hovering” state 809. In the “hovering” state 809, the vehicle 110 performs a hovering maneuver as discussed above.

When a “shortPush” input is received in the “hovering” state 809 this will cause another transition to the “ducking” state 810. Otherwise, a “longPush” input is used to transition the vehicle 110 from the “hovering” state 809 to the “returning” state 811 so that the vehicle 110 aborts the mission and returns to the base location 312 as discussed above. This will be accompanied by a unique “quadrupleBeep” output which only occurs when the mission is aborted in this manner. While the vehicle is in the “returning” state 811, another “longPush” input will cause a transition back to the “hovering” state 809.

In view of the above, it will be appreciated that the “shortPush” input will cause a transition into the “ducking” state 810 from either the “normal flight” state 808 or the “hovering” state 809. On the other hand, the “longPush” input will either cause a transition into the “hovering” state 809 from the “normal flight” state 808 or the “ducking” state 810 or toggle the vehicle between the “hovering” state and the “returning” state 811.

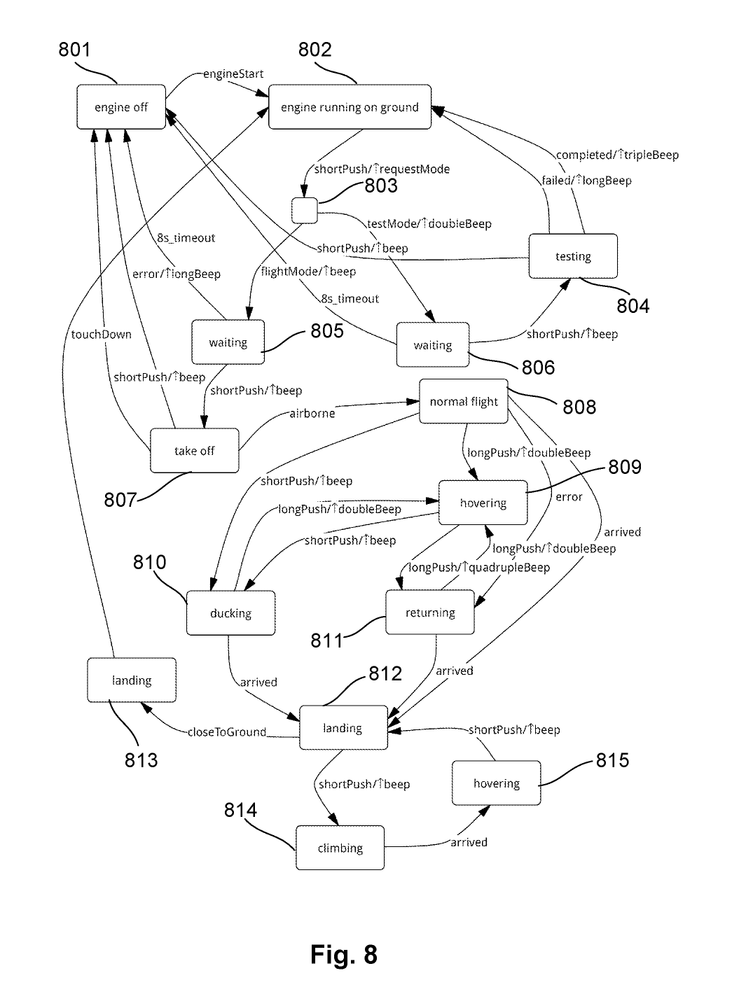

With regard to the state machine depicted in FIG. 9, this represents the operation of the system 100 in response to activations of the kill switch 122 of one of the remote user interfaces 120. The kill switch 122 may have on and off positions represented by the “killSwitchOn” and “killSwitchOff” events in FIG. 9.

When the vehicle 110 is in any “on ground” state 901, activation of the kill switch 122 (“killSwitchOn” event) will cause the vehicle 110 to transition to the “engine off” state 902 in which the engine of the vehicle 110 is turned off. Otherwise, once the vehicle 110 takes off and becomes airborne (“airborne” event), the vehicle 110 will transition to the “airborne” state 903. The vehicle 110 may return to the “on ground” state 901 when the vehicle lands and touches down on the ground (“touchDown” event).

Activation of the kill switch 122 (“killSwitchOn” event) in the “airborne” state will cause the vehicle 110 to transition to an “engine off and full collective” state 904 in which the engine of the vehicle 110 is turned off and full collective is applied to prevent autorotation. In either the “engine off” state 902 or the “engine off and full collective” state 904, deactivating the kill switch 122 (“killSwitchOff” event) will return the vehicle to the “on ground” state 901.

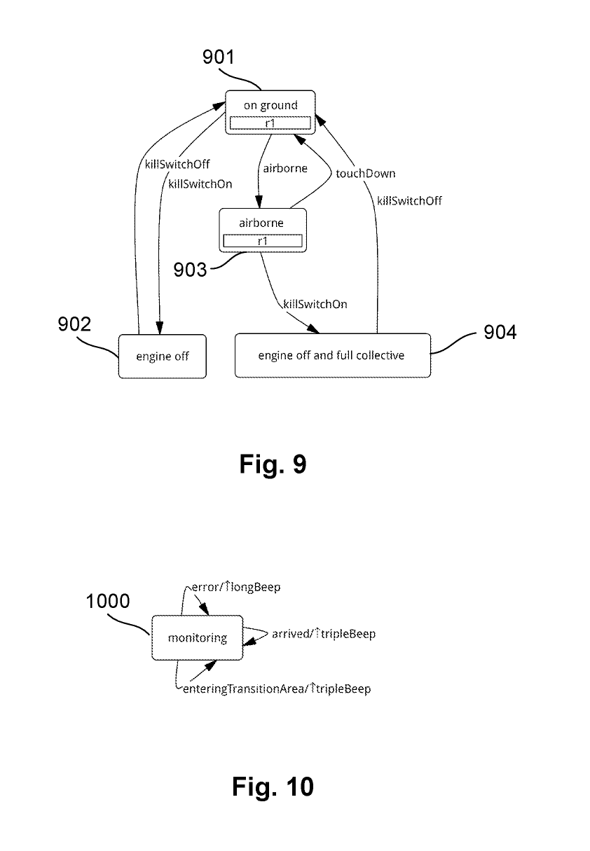

The state machine depicted in FIG. 10 represents the ongoing monitoring functionality of the unmanned aerial vehicle system 100, in a single “monitoring” state 1000. When an error is detected (“error” event), this triggers a “longBeep”, whilst a “tripleBeep” is triggered in the event of either the vehicle 110 arriving at the base location 312 (“arrived” event) or the vehicle 110 entering a transition area 340 (“enteringTransitionArea” event).

In view of the above, it will be appreciated that the state machines of FIGS. 8 to 10 facilitate the control of the vehicle 110 in accordance with user commands input in different operational contexts and in response to other events that may be encountered during operations of the vehicle 110.

An example of a specific embodiment of an unmanned aerial vehicle system 100 and methods for controlling the operation of the vehicle 110 in accordance with the above discussed techniques will now be described.

In this example, the unmanned aerial vehicle system 100 is specifically provided for facilitating unmanned low-altitude aerial surveys over forested mountainous terrain, in order to detect pest plant species for control or eradication. It will be appreciated that there is a strong safety case for carrying out operations of this type using an unmanned aerial vehicle system 100 due to the inherent risks of manned flight in forested mountainous terrain at sufficiently low altitudes to allow specific plant species to be differentiated from other plant species.

In this example, the vehicle 110 is a Vario Benzin Trainer unmanned helicopter which is commercially available as a remote controlled helicopter kit. The vehicle 110 includes a payload carrier (not shown), which is the mechanical structure holding most of the payload 150. The payload carrier mainly consists of an extended undercarriage with spring suspension and a vibration isolated carrier board with enclosure.

The payload 150 carried by the vehicle 110 in this case includes a camera system for use in the surveys. The camera system consists of a 5MP machine vision camera, a servo with mount and an embedded camera computer. The camera is mounted underneath the carrier board and the camera computer inside the enclosure on the carrier board.

A remote pilot is able to manually control the vehicle 110 using a standard remote controller 130, which may operate on a 2.4 GHz transmitter frequency. The vehicle 110 includes a remote control interface, which is provided as a custom developed circuit board with the electronics required to communicate between a flight computer of the vehicle and a remote controller receiver and actuators such as flight control servos. It also connects to sensors needed for engine control and the fuel system. The remote controller 130 is used for manual flight during flight testing or to activate and deactivate autonomous flight.

The vehicle 110 has been fitted with customised avionics and a set of wireless remote user interfaces 120 for use by the remote pilot in the capacity of a first observer 321 and any additional observers 331, as discussed above. In this case, the remote user interfaces 120 operate on a 900 MHz communication frequency.

For flight testing, the operator can also communicate with the helicopter through a ground station computer which displays real-time telemetry information and allows selection of different modes of the vehicle 110 and uploading simple flight plans during flight.

Each remote user interface 120 allows a user to terminate a flight once the vehicle 110 is beyond the remote controller 130 transmitter range, or to abort the mission and/or command a special aircraft avoidance maneuver. Multiple remote user interfaces 120 can be used if more than one observer 321, 331 is required. All communication links are omni-directional. While on the ground, communication with the flight and camera computers is possible through wired Ethernet.

The electrical system required to power the remote control interface and associated components is integrated on the same circuit board as the remote control interface. It connects to an external battery on the carrier board and has a backup battery on the circuit board. In this example, the circuit board is mounted in the nose of the helicopter on a vibration isolated frame. The electrical system for powering the rest of the avionics is integrated on the carrier board. The main power supply is a 3 cell lithium polymer battery which is also attached to the carrier board. While the helicopter is on the ground it is powered through a 12V external power supply.

The fuel system of the vehicle 110 consists of a main fuel tank in the nose of the helicopter, an auxiliary tank mounted on the frame of the extended undercarriage, a fuel pump, a fuel level sensor in the main tank, fuel tubing and a control system for the fuel pump.

For autonomous flight, the vehicle 110 requires a mission plan prior to take-off. In this example, the mission plan is saved as a file in XML format and consists of a sequence of waypoints and an identifier defining the path between the waypoints. A mission planning tool was developed which helps to create mission plans optimised for aerial surveys in mountainous environments. It requires a digital terrain model of the mission area.

All images captured by the camera system are recorded on-board the vehicle 110 and not transmitted to the ground during flight. The image analysis is conducted manually after the flight. A visualisation tool was developed which facilitates an easy analysis through fast access of the images and relating them to a 2D map of the mission area and the digital terrain model.

The vehicle 110 includes an autopilot system for facilitating the autonomous flight of the vehicle 110 and an obstacle detection system for preventing collisions with unplanned objects in the flight path 310.

It will be appreciated that references to the autopilot system refer to any hardware and software needed for guidance, navigation and control of the vehicle 110. In this case, the autopilot system incorporates a microprocessor based embedded flight computer 200, an Attitude and Heading Reference System (AHRS), a GPS receiver, a barometric pressure sensor and a microcontroller. The autopilot system may incorporate logical modules provided by the processing systems 210 of the flight computer 200, such as the guidance module and the flight control module as discussed in examples above. The flight computer 200 is mounted inside the enclosure on the carrier board. It communicates with the remote controller interface board through RS232 and digital I/O connections. The flight computer runs a real-time Linux based operating system with the ESM software framework. The algorithms are implemented in ESM and C.

The obstacle detection system has been optimised for detection of unexpected terrain obstacles or objects during an obstacle avoidance mode of flight, and also allows the vehicle 110 to operate in a terrain following mode of flight. The obstacle detection system consists of a radar sensor 141 and a servo actuated moveable mount 142. The radar sensor 141 is mounted underneath the carrier board and can be commanded to point in any direction from vertically down to horizontally forward. Radar readings in the form of range signals are processed in the flight computer and the servo for moving the moveable mount 142 is controlled by a mount control module provided by the flight computer.

Risks of extended line of sight operations are mitigated through highly dependable automation of the vehicle 110 including a flight termination system ensuring containment in a defined mission area and procedural means. The systems and procedures have been developed for operations in airspace over unpopulated terrain at a typical operational altitude of less than 200 ft above ground level (AGL). It is therefore assumed that the air traffic density is low and that the flight can be terminated anywhere in the mission area without causing serious damage to property.

The remote pilot is typically a qualified pilot and is ultimately responsible for the operation of the vehicle 110 from engine start to engine shutdown after landing. As mentioned above, the remote pilot, also acting as a first observer 321, has a remote user interface 120 in wireless communication with the helicopter and communicates with other observers 331 by mobile phone, UHF radio or directly if the other observer 331 is nearby. At least one voice communication channel to an observer 331 who is tasked to keep the helicopter in sight must be working. The pilot also operates a VHF radio to communicate with other aircraft. The pilot makes decisions based on what he or she observes or information he or she receives from observers 331 and other aircraft.

The pilot has several options to manage the flight with regards to collision avoidance and prevention of flight into bad weather (IMC): flying the helicopter manually, commanding a vertical descent, commanding to hover, commanding a return flight or terminating the flight. These options also help to manage the risk of rare failures of other autonomous systems of the vehicle 110, such as to provide static obstacle avoidance and geofencing.

The main task of observers 321, 331 other than the pilot is to ensure safe operation of the vehicle 110 by avoiding collisions with other traffic, whilst the vehicle 110 is in the observer's observation area 320, 330. Apart from that, observers 321, 331 may report weather observations to the pilot to make sure operations stay in visual meteorological conditions (VMC). Observation duty is handed over in pre-defined transition areas 340 following a handover procedure.

There are two kinds of observers: observers who can directly communicate with the pilot because they are close to the pilot and remote observers communicating through radio links. Remote observers carry remote user interfaces 120 which extend the communication range to the helicopter and allow dealing with situations that require quick reaction. In a threatening situation a remote observer 321, 331 can terminate a flight without consulting the pilot. As long as the pilot and the observers 321, 331 close to the pilot have the helicopter in sight, a remote observer 321, 331 does not need to command the vehicle 110 unless advised by the pilot.

With regard to the remote user interfaces 120, several users can use these to wirelessly interact with the vehicle 110 at any time. All remote user interfaces 120 have same priority. As discussed above, the remote user interface 120 has one command input 121 and a kill switch 122. In this example, the remote user interface 120 also includes two flashing lights: one indicating radio link to the helicopter (ping), the other battery status and heartbeat signal of the interface computer. The remote user interface 120 may also include an audio or vibrational feedback device for confirming inputs or events to the user.

The command input 121 is implemented as a push button, and using this a user can command:
engine test (on ground);
mission start including take-off;
abort mission and vertical descent to ˜10 m above ground (ducking for aircraft avoidance);
abort mission, vertical climb to 200 ft AGL and return to home base;
abort mission and hover;
abort landing and retry; or,
engine shutdown.

In this example, all commands are acknowledged through an audio signal. One of the remote user interfaces 120 can be replaced by a ground station which offers the same functionality for commanding the aircraft but also includes visualisation of telemetry data. This allows the pilot to monitor the progress of the flight plan execution and the health of the aircraft. Apart from that, the pilot can also fly the vehicle 110 manually through the aforementioned standard remote controller 130.

The vehicle 110 is configured to include a flight termination system which stops the engine and applies full collective pitch, particularly when a terminate condition is encountered as discussed above. This results in a ballistic trajectory flight of the helicopter to the ground ensuring impact within short distance after activation. In this example, the flight termination is activated in the following cases:
activation by user (kill switch 122);
helicopter leaves the mission area 310 (geofence);
unrecoverable malfunctioning of the avionics;
GPS loss or altitude sensor failure; or,
loss of radio link to both user interfaces and the RC transmitter.

The aforementioned geofence is defined horizontally and vertically. The horizontal boundary is defined by a polygon with vertices in World Geodetic System 84 (WGS84) coordinates. The upper vertical boundary is 400 ft AGL. For the purpose of this implementation, AGL is defined as “the height above the highest point of the terrain, and any point on it, within a radius of . . . 300 metres”. The height is either determined based on pressure height in combination with a high-resolution terrain model or measured directly using a radar altimeter.

In case voice communication with the remote observer 331 monitoring the area the vehicle 110 is flying to cannot be maintained while the vehicle 110 is within line-of-sight of the pilot or a close observer, the helicopter shall be commanded to return to a home base location 312. In case the vehicle 110 is only within line-of-sight of a remote observer 331 and not in sight of the pilot, he or she shall command the vehicle 110 to hover using the remote user interface 120. This gives the pilot time trying to re-establish communication with the observer 321. If this cannot be achieved within a specified time, the remote observer 321 shall terminate the flight.

The vehicle 110 may decide autonomously to abort a mission (e.g. in case of engine problems) or this can be commanded by a user using a remote user interface 120. When a mission is aborted, the vehicle 110 returns to the home base location 312 using a radar-based terrain following flight mode ensuring to stay below 400 ft AGL. The vehicle 110 flies through pre-defined waypoints in the transition areas 340 ensuring it remains within line-of-sight of at least one of the pilot or observers at all times. The handover procedures are the same as for a normal return flight. The typical cruise height during the return flight is 200 ft AGL. It is ensured that such a return flight from any location in the mission area is possible without leaving the area and without entering a no-fly-zone.

It is noted that there are failure cases where the vehicle 110 could be commanded to return to the base location 312 instead of terminating the flight. However, in this example, the flight would be terminated to comply with the requirement to have the helicopter within line-of-sight and maintaining communication between the pilot and the remote observers at all times.

As described in examples above, observation handovers occur in pre-defined transition areas 340 in which the vehicle 110 is expected to be visible by the two remote observers 321, 331 monitoring the two adjacent observation areas 320, 330. The observer 331 of the area the vehicle 110 is about to enter must confirm that the vehicle 110 is in sight and radio link to the vehicle 110 has been established before it flies beyond line-of-sight of the other observer. If this does not occur and the vehicle 110 is still in the first observation area 320, it shall be commanded to return using any of the remote user interfaces 120. If the vehicle 110 is in another observation area 330, it shall be commanded to hover using any of the remote user interfaces 120. This gives the next observer 331 time to spot the vehicle 110 and once it is spotted it shall be commanded to return. If this cannot be achieved within a specified time, the flight shall be terminated using any of the remote user interfaces 120.

In case the observer 321, 331 who is currently tasked to keep the vehicle 110 in sight loses visual contact to the vehicle 110, the observer 321, 331 shall contact the pilot immediately. If no observer 321, 331 has visual contact within 5 s, a vertical climb to 200 ft AGL shall be commanded using any of the remote user interfaces 120. If visual contact has not been established within 30 s, the flight shall be terminated using any of the remote user interfaces 120.

It is noted when executing a ducking command, there is a risk to lose visual contact to the vehicle 110 as the view could get obstructed by the terrain or other obstacles such as trees. In that situation the descent shall be stopped before losing visual contact if there is sufficient separation to conflicting air traffic. The altitude of the vehicle 110 can be controlled by alternating the return flight, ducking and hovering commands.

Further specific implementation details of the above discussed autopilot system will now be described.

The autopilot is responsible for flying the vehicle 110 and making appropriate decisions during operation of the vehicle 110 to execute its mission and to return the vehicle 110 to the base location 312. It includes a flight computer and a number of navigation sensors, a navigation system, a flight controller, and a guidance system. The autopilot system has been augmented by two key systems: an obstacle detection/avoidance system, and a terrain following system. These two systems significantly enhance the safety and efficiency of the aerial survey operations undertaken by the vehicle 110 in this example.

The flight computer 200 is the core of the autopilot hardware that runs all required flight control algorithms as outlined below. The flight computer 200 communicates with several sensors and boards to read sensing measurements and send low-level commands to the interface board through RS232 and digital IO. Navigation sensors are safety critical components that need to be chosen and integrated into the platform adequately. Sensors used onboard the helicopter for autonomous navigation include a GPS module, an Inertial Measurement Unit (IMU), a barometric height sensor and an airborne radar altimeter (used as the radar sensor 141 for the obstacle detection system).

The navigation system includes three main algorithms that fuse data from different sensors to estimate the helicopter states that are required for automatic control of its pose:
An Attitude and Heading Reference System (AHRS), which estimates the helicopter angles (pitch, roll and yaw) and angular rates;
A GPS-INS state estimation system that fuses data from the GPS module and the IMU using an Extended Kalman Filter (EKF). This filter provides position and velocity estimates at an update rate of 100 Hz; and,
Vertical motion estimation using a linear Kalman Filter that combines measurements from a barometric pressure sensor and an IMU. These estimates are more accurate and reliable that the ones provided by GPS.

It is noted that all of these algorithms include some kind of monitoring functions that provide some data about the health and integrity of the sensors as well as the state estimates, which may be used in determining whether to abort the mission or terminate flight of the vehicle as discussed above.

The flight controller consists of several nested control loops that are based on the standard Proportional-Integral-Derivative (PID) controllers. The flight controller provides the helicopter with the capabilities of stabilizing its flight (hovering) but also tracking any feasible trajectory. Different PID control loops can be activated based on the flight mode that has been selected by the guidance system.

The guidance system has the role of mapping the flight plan (set of primitives or waypoints) into reference positions and/or velocities for the flight controller. It has thus the tasks of: 1) reading the flight plan and transforming it into a suitable representation; 2) generating flight primitives (sequencer); 3) checking each flight primitive; 4) selecting the appropriate flight mode for each primitive; 5) generating the reference trajectories for the controller in order to track a given primitive; 6) ensuring smooth transitions between primitives; and 7) monitoring the execution of tasks (e.g., tracking of a given primitive). The flight plan may be modelled by a set of motion primitives. Contrary to the traditional waypoints, primitives offer not only a way to reach a 3D point in space but also how to reach it, thereby having more control on the helicopter states along all the flight path.

The main feature of the guidance system is that it allows the vehicle 110 to execute a flight plan efficiently and safely. For example, it allows the vehicle 110 to fly relatively complex trajectories (e.g., a horizontal trajectory followed by a sloped segment and then a curved trajectory) without stopping. In addition to these basic functionalities, the guidance system has been augmented by a number of monitoring functions that monitor the health of the vehicle 110 and its sensors, the trajectory tracking errors, flight envelope and performance, mission execution, and many others. As discussed above, if the system detects a non-critical issue with one of these components, it aborts the mission and commands the vehicle 110 to fly home using the terrain following mode, or if the system detects a safety critical issue, it terminates flight of the vehicle 110.

As the specific implementation of the system 100 in this example is designed and intended for low altitude flights (about 30 m) over difficult and mountainous terrain, it is imperative to equip the vehicle 110 with a reliable obstacle detection system to enhance its safety and survivability.

Although LIDAR maps may be used to generate “obstacle-free” flight plans, the vehicle 110 may still encounter obstacles along its path due to localization/state estimation errors, or the presence of new obstacles that were not included in the LIDAR maps. The vehicle 110 has been equipped with a radar sensor 141 because of the reliability and maturity of this technology but also because of its relatively long range and relatively lightweight. The selected radar sensor 141 (which is available commercially in the form of an airborne radar altimeter) has a field of view of about 40×40 degrees which is not sufficient to guarantee safety in different flight modes in a single orientation. It has been therefore mounted on a servo actuated moveable mount 142 mechanism that can change its orientation from horizontal to vertical.

The algorithm used for obstacle detection and avoidance in this specific example has the following features:
The radar sensor 141 is commanded to point in the flight direction in order to avoid flying blindly into “unseen” obstacles;
The filtered range measurements are continuously compared to preset thresholds (e.g. 20 m when for forward flight and 8 m for vertical flights); and,
When an obstacle is detected (i.e., the radar range is below the threshold), the helicopter is automatically commanded to perform an emergency brake and fly home using the terrain following mode.

The terrain following system was developed to bring the vehicle 110 home from any location in the mission area and to do so efficiently and safely. As mentioned before, the monitoring modules of the guidance system and the obstacle avoidance system can automatically abort the mission and activate the terrain following-based homing (or auto-return). A ground station operator, pilot or one of the observers can also abort the mission at any moment/time and command the terrain following-based homing.

When a mission is aborted and homing mode is activated, it means that there is a problem with the helicopter system or with its surrounding (e.g., bad weather, obstacle, etc.). It is therefore important to fly or return home using an efficient route (such as a straight path to the home location, if possible within observation constraints). LIDAR maps may also not be always available for the area that is between the abort location and the base location 312, which means that it can be hard to plan an efficient homing route.

Horizontal straight-line homing using terrain following mode to adjust the helicopter height is an attractive option for such situations. The objective is to fly low enough to avoid manned aircraft and comply with relevant regulations but also to keep a safe separation from terrain and obstacles.

A Radar Terrain Following (RTF) system has therefore been developed that is optimised for heights that are around 60 m AGL. A number of heuristics have been also added to the system to allow it to handle different positive and negative slopes, ranging from −90 degrees (pure vertical descent) to +90 degrees (pure vertical climb). During the terrain following mode, the radar sensor 141 is pointing −45 degrees forward in order to sense the terrain but also potential forward obstacles and steep slopes.

In view of the above examples, it will be appreciated that the safety of unmanned aerial vehicle operation can be significantly improved through the application or one or more of the above described techniques. These techniques are especially beneficial for facilitating safer extended visual line of sight operations.

For example, the above described procedures for handling handovers of observation duties between observers 321, 331 will help to prevent situations where the vehicle 110 operates without at least one observer 321, 331 having visual contact with the vehicle 110. As discussed, these procedures can be facilitated using simplified remote user interfaces 120 that can allow observers 321, 331 to take necessary actions in the event of a failed handover or if a safety threat such as an imminent collision with other air traffic is observed.

The above described procedures for detecting abort conditions or terminate conditions and automatically responding in a suitable manner can compliment these handover procedures by ensuring the vehicle 110 only continues its mission or flight when it is safe to do so. This can also help to reduce the burden on any observers 321, 331 so that they can focus on maintaining the vehicle 110 in visual contact and watching for collision risks without the need to constantly monitor other conditions of the vehicle 110.

Finally, the use of the above described moveable radar sensor arrangement 140 can enable a range of different and useful flight modes to be controlled using the same radar sensor 141, with the obstacle avoidance mode and terrain following mode being particularly advantageous in the context of extended visual line of sight operations.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

The claims defining the invention are as follows:

1) A method of controlling an unmanned aerial vehicle executing a mission in a defined mission area including a first observation area within a visual line of sight of a first observer, a second observation area within a visual line of sight of a second observer, and a transition area within the visual line of sight of both the first observer and the second observer, the method including:
a) the vehicle moving into the transition area after completing part of the mission within the first observation area, in sight of the first observer; and,
b) in response to the vehicle moving into the transition area, determining whether the vehicle is in sight of the second observer, wherein:
i) if the vehicle is in sight of the second observer, the vehicle is allowed to continue the mission in the second observation area; and,
ii) if the vehicle is not in sight of the second observer, determining whether the vehicle is in sight of the first observer, wherein:
(1) if the vehicle is in sight of the first observer, causing the vehicle to:
(a) abort the mission; and,
(b) return to a base location via the first observation area; and,
(2) if the vehicle is not in sight of the first observer, terminating flight of the vehicle.

2) A method according to claim 1, wherein the method includes:
a) each of the first and second observers communicating with the other observer to confirm whether the vehicle is in their sight;
b) optionally, when the vehicle moves into the transition area, the second observer communicating with the first observer to confirm whether the vehicle is in sight of the second observer;
c) optionally, the first and second observers communicating using wireless voice communications; and,
d) optionally, in response to a loss of wireless voice communications:
i) if the vehicle is in sight of the first observer, causing the vehicle to:
(1) abort the mission; and,
(2) return to a base location via the first observation area; and,
ii) if the vehicle is not in sight of the first observer but is in sight of the second observer:
(1) causing the vehicle to perform a hovering maneuver; and,
(2) if wireless voice communications are not re-established within a predetermined duration, terminating flight of the vehicle.

3) A method according to claim 1 or claim 2, wherein:
a) each of the first and second observers has a respective remote user interface for allowing the respective observer to input user commands, the method including the vehicle responding to user commands received from one of the remote user interfaces; and,
b) optionally the user commands include:
i) an abort command for causing the vehicle to:
(1) abort the mission; and,
(2) return to the base location; and,
ii) a terminate command for terminating flight of the vehicle.

4) A method according to claim 3, wherein the method includes at least one of:
a) when the vehicle moves into the transition area and if the vehicle is in sight of the first observer but is not in sight of the second observer, the first observer inputting an abort command;
b) if the vehicle is not in sight of any of the observers for a predetermined duration, either of the observers inputting a terminate command; and,
c) causing the remote user interface to provide information to the respective observer using speech output.

5) A method according to claim 3 or claim 4, wherein the user commands further include:
a) a hover command for causing the vehicle to perform a hovering maneuver; and,
b) a duck command for causing the vehicle to perform a ducking maneuver.

6) A method according to claim 5, wherein the method includes:
a) when the vehicle moves into the transition area and if the vehicle is not in sight of any of the observers, either of the observers inputting a hover command;
b) optionally, when the vehicle is performing a hovering maneuver and if the first observer regains sight of the vehicle, the first observer inputting an abort command;
c) optionally, when the vehicle is performing a hovering maneuver and if the first observer fails to regain sight of the vehicle within a predetermined hover duration, the first observer inputting a terminate command; and,
d) optionally, if one of the observers identifies a risk of collision between the vehicle and air traffic in the respective observation area, the observer inputting a duck command.

7) A method according to any one of claims 3 to 6, wherein:
a) each remote user interface includes:
i) a command input for allowing a user to input at least an abort command; and,
ii) a kill switch for allowing a user to input a terminate command; and,
b) optionally the method includes causing the vehicle to perform a maneuver in response to activation of the command input depending on at least one of:
i) a duration of the activation;
ii) a current flight mode of the vehicle; and,
iii) a number of activations in a defined time period.

8) A method according to any one of claims 3 to 7, wherein at least one of the observers wears spotting glasses coupled to the respective remote user interface, the method including causing the spotting glasses to provide visual indicators for prompting the observer to look towards the vehicle.

9) A method according to claim 8, wherein:
a) the spotting glasses include:
i) an orientation sensor for providing orientation data;
ii) a sight positioned in an observer's field of view when worn; and,
iii) pan and tilt indicator lights, wherein the method includes selectively activating the pan and tilt indicator lights based on the orientation data to prompt the observer to rotate their head to so that the sight points towards the vehicle; and,
b) optionally the method includes the remote user interface selectively activating the pan and tilt indicator lights by:
i) comparing position data indicative of the respective positions of the observer and the vehicle to determine a required orientation;
ii) comparing the orientation data to the required orientation to determine required rotations to achieve the required orientation; and,
iii) selectively activating the pan and tilt indicator lights to indicate the required rotations.

10) A method according to any one of claims 1 to 9, wherein the method includes:
a) the vehicle returning to the transition area whilst returning to the base location from the second observation area, in sight of the second observer; and,
b) in response to the vehicle moving into the transition area, determining whether the vehicle is in sight of the first observer, wherein:
i) if the vehicle is in sight of the first observer, the vehicle is allowed to continue to return to the base location via the first observation area; and,
ii) if the vehicle is not in sight of the first observer, terminating flight of the vehicle.

11) A method according to any one of claims 1 to 10, wherein the first observer is a pilot having a remote control interface for allowing the pilot to input flight commands, the method including:
a) the vehicle responding to flight commands received from the remote control interface; and,
b) optionally, if one of the observers identifies a risk of collision between the vehicle and air traffic in the respective observation area, the pilot inputting flight commands to take over control of the vehicle.

12) A method according to any one of claims 1 to 11, wherein the mission area includes a plurality of observation areas, each having a respective observer, and a plurality of transition areas in overlapping areas of adjacent pairs of the observation areas, the method including the vehicle returning to the base location via any transition areas between the current vehicle position and the base location.

13) A method of controlling an unmanned aerial vehicle executing a mission in a defined mission area, the vehicle including one or more processing systems in wireless communication with one or more remote user interfaces, the method including, in the one or more processing systems:
a) detecting whether the vehicle has encountered an abort condition or a terminate condition based on at least one of:
i) a user command received from a remote user interface; and,
ii) sensor data received from sensors of the vehicle;
b) in response to detecting an abort condition:
i) causing the vehicle to:
(1) abort the mission; and,
(2) return to a base location within the mission area; and,
ii) detecting whether the vehicle has subsequently encountered a terminate condition while returning to the base location; and,
c) in response to detecting a terminate condition, terminating flight of the vehicle.

14) A method according to claim 13, wherein at least one of:
a) the abort condition includes at least one of:
i) receiving, from the remote user interface, an abort command; and,
ii) detecting, based on the sensor data, a non-critical issue that will inhibit execution of the mission, wherein the non-critical issue includes at least one of:
(1) a low fuel level;
(2) a low battery charge level;
(3) an engine warning;
(4) a mission equipment malfunction;
(5) entering a geofence buffer zone;
(6) deviation from a vehicle flight envelope; and,
(7) an excessive trajectory tracking error.
b) the terminate condition includes at least one of:
i) receiving, from the remote user interface, a terminate command; and,
ii) detecting, based on the sensor data, a critical issue that will prevent safe operation of the vehicle, wherein the critical issue includes at least one of:
(1) the vehicle leaving the mission area;
(2) a loss of a global positioning system signal;
(3) a loss of wireless communication with the one or more remote user interface units;
(4) an unrecoverable malfunction of an avionics system of the vehicle;
(5) a failure of a critical sensor of the vehicle, wherein the critical sensor includes at least one of:
(a) a pressure altimeter of the vehicle;
(b) a positioning sensor of the vehicle; and,
(c) a radar sensor of the vehicle;
(6) a failure of a flight computer of the vehicle;
(7) a failure of an inertial measurement unit of the vehicle;
(8) a failure of an attitude and heading reference system of the vehicle; and,
(9) a failure of an electric power system of the vehicle.

15) A method according to claim 14, wherein the method includes at least one of:
a) detecting the low fuel level by at least one of:
i) determining that a fuel level is below a predetermined fuel level threshold; and,
ii) determining that the fuel level is insufficient to complete the mission;
b) detecting the low battery charge level by determining that a battery charge level is below a predetermined battery charge threshold;
c) detecting deviation from the flight envelope by determining that flight parameters of the vehicle are outside vehicle flight envelope parameters; and,
d) detecting the excessive tracking error by determining that a trajectory tracking error is greater than a predetermined tracking error threshold.

16) A method according to any one of claims 13 to 15, wherein the vehicle includes an obstacle detection sensor, the method including:
a) detecting an abort condition when the obstacle detection sensor detects an object ahead of the vehicle while the vehicle is executing the mission; and,
b) optionally detecting a terminate condition when the obstacle detection sensor detects an object ahead of the vehicle while the vehicle is returning to the base location after the mission has been aborted.

17) A method according to any one of claims 13 to 16, wherein the one or more processing systems provide a guidance module for generating flight commands and a flight control module for controlling flight of the vehicle based on the flight commands, the method including:
a) in the absence of an abort condition or a terminate condition, the guidance module generating flight commands for causing the vehicle to execute the mission according to a predefined mission flight plan; and,
b) in response to detecting an abort condition, the guidance module generating flight commands for causing the vehicle to return to a base location.

18) A method according to claim 17, wherein:
a) the method includes, in response to detecting an abort condition, the guidance module generating a return to base flight plan for returning the vehicle from a current vehicle position to the base location;
b) optionally the mission area includes first and second observation areas and a transition area in an overlapping area of the first and second observation areas, the method including the guidance module generating the return to base flight plan so that the vehicle returns to the base location via the transition area; and,
c) optionally the mission area includes a plurality of observation areas and a plurality of transition areas in overlapping areas of adjacent pairs of the observation areas, the method including the guidance module generating the return to base flight plan so that the vehicle returns to the base location via any transition areas between the current vehicle position and the base location.

19) A method according to any one of claims 13 to 18, wherein:
a) each remote user interface includes:
i) a command input for allowing a user to input an abort command; and,
ii) a kill switch for allowing a user to input a terminate command; and,
b) optionally the method includes causing the vehicle to perform a maneuver in response to activation of the command input depending on at least one of:
i) a duration of the activation;
ii) a current flight mode of the vehicle; and,
iii) a number of activations in a defined time period.

20) A method according to claim 19, wherein:
a) the method includes causing the vehicle to:
i) perform a ducking maneuver in response to a short activation of the command input; and,
ii) perform a hovering maneuver in response to a long activation of the command input; and,
b) optionally the method includes receiving an abort command in response to another long activation of the command input when the vehicle is performing a hovering maneuver.

21) An unmanned aerial vehicle including:
a) a radar sensor mounted on the vehicle using a moveable mount for moving the radar sensor between different radar orientations, the radar sensor generating a range signal; and,
b) one or more processing systems for providing:
i) a mount control module configured to control the moveable mount to move the radar sensor into one of the radar orientations based on a current one of a plurality of flight modes; and,
ii) a flight control module configured to control flight of the vehicle using the range signal, based on the current flight mode.

22) An unmanned aerial vehicle according to claim 21, wherein the plurality of flight modes includes an obstacle avoidance mode, in which:
a) the mount control module causes the moveable mount to move the radar sensor into an obstacle avoidance orientation in which the range signal is indicative of a distance between the vehicle and any object in a flight direction of the vehicle; and,
b) the flight control module initiates at least one obstacle avoidance measure if the range signal falls below an obstacle avoidance range threshold.

23) An unmanned aerial vehicle according to claim 22, wherein at least one of:
a) the obstacle avoidance orientation points the radar sensor in one of:
i) a substantially forward direction relative to the vehicle; and,
ii) a direction that is substantially aligned with the flight direction of the vehicle;
b) the obstacle avoidance mode is activated as the current flight mode when the vehicle is executing a mission; and,
c) the obstacle avoidance range threshold is determined based on at least one of:
i) a flight speed of the vehicle; and,
ii) a flight direction of the vehicle.

24) An unmanned aerial vehicle according to claim 22 or 23, wherein the at least one obstacle avoidance measure includes at least one of:
a) causing the vehicle to decelerate;
b) causing the vehicle to hover;
c) causing the vehicle to climb in altitude;
d) causing the vehicle to attempt to steer around an object;
e) causing the vehicle to abort a mission;
f) causing the vehicle to return to a base location;
g) causing the vehicle to decelerate to a stop then automatically return to a base location; and,
h) causing the current flight mode of the vehicle to transition from the obstacle avoidance mode to a different one of the plurality of flight modes.

25) An unmanned aerial vehicle according to any one of claims 21 to 24, wherein the plurality of flight modes includes a terrain following mode, in which:
a) the mount control module causes the moveable mount to move the radar sensor into a terrain following orientation in which the range signal is indicative of a distance between the vehicle and terrain ahead of the vehicle; and,
b) the flight control module causes the vehicle to maintain at least a minimum separation from the terrain based on the range signal.

26) An unmanned aerial vehicle according to claim 25, wherein at least one of:
a) the terrain following orientation points the radar sensor in an angled direction that is rotated downwardly from a forward direction relative to the vehicle, to thereby allow the radar sensor to detect the terrain ahead of the vehicle and any object in a flight direction of the vehicle;
b) the terrain following orientation points the radar sensor in an angled direction that is at least one of:
i) rotated downwardly from the forward direction by an angle of between 30 degrees and 60 degrees; and,
ii) rotated downwardly from the forward direction by an angle of approximately 45 degrees; and,
c) the terrain following mode is activated as the current flight mode when the vehicle has aborted a mission and is returning to a base location.

27) An unmanned aerial vehicle according to claim 25 or claim 26, wherein, in the terrain following mode, the flight control module at least one of:
a) causes the vehicle to maintain at least the minimum separation from the terrain by controlling an altitude of the vehicle above the terrain;
b) controls the altitude of the vehicle between a maximum altitude limit and a minimum altitude limit that provides the minimum separation from the terrain;
c) increases the altitude of the vehicle when the range signal falls below a terrain following range threshold; and,
d) regulates a ground speed of the vehicle based on the range signal.

28) An unmanned aerial vehicle according to any one of claims 21 to 27, wherein the plurality of flight modes includes a vertical flight mode, in which:
a) the mount control module causes the moveable mount to move the radar sensor to an altimeter orientation in which the range signal is indicative of an altitude of the vehicle above terrain beneath the vehicle; and,
b) the flight control module controls vertical flight of the vehicle based on the range signal.

29) An unmanned aerial vehicle according to claim 28, wherein at least one of:
a) the altimeter orientation points the radar sensor in a downward direction relative to the vehicle, to thereby allow the radar sensor to detect the terrain beneath the vehicle;
b) the vertical flight mode is activated as the current flight mode when the vehicle is performing at least one of:
i) a take-off maneuver;
ii) a landing maneuver;
iii) a hovering maneuver;
iv) a ducking maneuver; and,
v) an altimeter adjustment maneuver; and,
c) in the vertical flight mode, the flight control module uses the range signal to determine a height above ground estimation, the height above ground estimation being used to adjust a pressure altimeter of the vehicle.

30) An unmanned aerial vehicle according to any one of claims 21 to 29, wherein the mount control module is configured to control the moveable mount to move the radar sensor into one of the radar orientations based on at least one of:
a) a velocity of the vehicle; and,
b) an altitude of the vehicle.
